(19) United States
(12) Patent Application Publication
(10) Pub. No.: US 2023/0214917 A1
(43) Pub. Date: Jul. 6, 2023

(54) SYSTEMS AND METHODS OF CONTRACTOR ANALYSIS FOR CREDIT ADJUSTMENT

(71) Applicant: Billd, LLC, Austin, TX (US)

(72) Inventor: Christopher Lee Doyle, Austin, TX (US)

(21) Appl. No.: 18/092,715

(22) Filed: Jan. 3, 2023

Related U.S. Application Data
(60) Provisional application No. 63/295,643, filed on Dec. 31, 2021.
(60) Provisional application No. 63/295,646, filed on Dec. 31, 2021.

(51) Int. Cl. G06Q 40/03; G06Q 10/0639; G06Q 50/08

(52) U.S. Cl. CPC G06Q 40/03; G06Q 10/06393; G06Q 50/08

(57) ABSTRACT

Disclosed herein are systems and methods for contractor analysis. A system receives contractor information associated with a contractor. The contractor information includes financial information about the contractor and business information about the contractor. The system generates a contractor quality score based on the contractor information. The system establishes an account credit offer based on the contractor information, and adjusts the account credit offer based on the contractor quality score.

### CROSS REFERENCE TO RELATED APPLICATIONS

This application claims the benefit of U.S. Provisional Application No. 63/295,643, filed Dec. 31, 2021, titled “SYSTEMS AND METHODS FOR USING A CONTRACTOR QUALITY SCORE TO ADJUST A CREDIT OFFER,” and U.S. Provisional Application No. 63/295,646, filed Dec. 31, 2021, titled “SYSTEMS AND METHODS FOR ADJUSTING A CREDIT LIMIT BASED ON LIEN DATA,” the disclosures of which are incorporated herein by reference in their entirety.

### FIELD OF THE DISCLOSURE

Exemplary embodiments of the subject disclosure relate generally to a system and a method for generating and/or adjusting a credit offer, and more particularly related, to a system and a method for analyzing information about a contractor, scoring the contractor on quality and/or risk, and/or using a score to generate and/or adjust a credit offer.

### BACKGROUND

In construction, contractors generally specialize in a specific trade (e.g. plumbing, woodwork, electrical, painting, windows, roofing, etc.). Different contractors that specialize in different trades generally work under a general contractor, who in turns works for a property owner or other stakeholder in the construction project. Costs and payments for different parts of a project, and for different contractors, can be complex. Sometimes, a contractor may seek a loan to have sufficient funds to work on a project (e.g., to pay for the contractor’s materials and labor), and can then repay the loan once the contractor’s portion of the construction project is complete or had hit certain milestones that cause the contactor to receive payment. Traditionally, contractors seeking loans are treated similarly to one another, regardless of different contractors having different attributes.

### SUMMARY

Disclosed herein are systems and methods for contractor analysis. A system receives contractor information associated with a contractor. The contractor information includes financial information about the contractor and business information about the contractor. The system generates a contractor quality score based on the contractor information. The system establishes an account credit offer based on the contractor information, and adjusts the account credit offer based on the contractor quality score.

In an illustrative example, a system is disclosed for contractor analysis. The system comprises: a memory; and a processor coupled to the memory, wherein the processor is configured to: receive contractor information associated with a contractor, wherein the contractor information includes financial information about the contractor and business information about the contractor; generate a contractor quality score based on the contractor information; establish an account credit offer based on the contractor information; and adjust the account credit offer based on the contractor quality score.

In another illustrative example, a method is disclosed for contractor analysis. The method comprises: receiving contractor information associated with a contractor, wherein the contractor information includes financial information about the contractor and business information about the contractor; generating a contractor quality score based on the contractor information; establishing an account credit offer based on the contractor information; and adjusting the account credit offer based on the contractor quality score.

### BRIEF DESCRIPTION OF THE DRAWINGS

FIG. 1 illustrates a diagram of a system architecture for practicing embodiments of the methods described herein, according to some examples.

FIG. 2 illustrates a block diagram of a system for practicing embodiments of the methods described herein, according to some examples.

FIG. 3. illustrates a diagram of a system architecture for practicing embodiments of the methods described herein, according to some examples.

FIG. 4 illustrates a block diagram of a base module for practicing embodiments of the methods described herein, according to some examples.

FIG. 5 illustrates a flow diagram showing a method for using a contractor quality score to adjust a credit offer, according to some examples.

FIG. 6 illustrates a flow diagram showing a method for acquiring contractor information, according to some examples.

FIG. 7 illustrates an exemplary contractor database, according to some examples.

FIG. 8 illustrates a flow diagram showing a method for generating the contractor quality score, according to some examples.

FIG. 9 illustrates a flow diagram showing a method for adjusting the credit offer, according to some examples.

FIG. 10 illustrates a flow diagram showing a method for adjusting a credit limit based on lien data, according to some examples.

FIG. 11 illustrates a flow diagram showing a method for the operations of adjusting the credit limit, according to some examples.

FIG. 12 is a block diagram illustrating use of one or more trained machine learning models of a machine learning engine to generate a contractor quality score for a contractor based on input data about the contractor, according to some examples.

FIG. 13 is a flow diagram illustrating a process for contractor analysis performed using an analysis system, according to some examples.

### DETAILED DESCRIPTION

In most commercial construction situations, Contractors, who specialize in a specific trade, work under a under a General Contractor who in turn works for the Property Owner. Contractors purchase materials or other items from a Supplier, who is paid by the Contractor. A Contractor may pay the Supplier by borrowing money from a lender. For example, a borrower may apply through a lender or an individual representing the lender or may submit an application electronically over the Internet. Credit offers are available from many different sources, such as traditional banks, and private and commercial money lenders. Further, lending institutions, such as banks, have assessed credit offer risk using credit reports and/or credit scores. Credit reports are records sent from a credit reporting agency to prospective lenders, employers, and insurers that provide information about the credit standing of a consumer. Credit reporting agencies are companies that gather information about consumers and sell it to creditors and/or employers and/or insurers. A Contractor may also make a payment agreement with a Supplier directly and pay according to a defined set of terms. For example, The Supplier might require the Contractor to pay within 30 days of receipts of the supplies.

Some processes for establishing credit offers facilitate lenders to evaluate factors such as credit score, income, age of credit, outstanding debt, historical payment performances, and asset recovery value related to the borrower. A credit score often refers to a number generated by a statistical model that is used to objectively evaluate the creditworthiness of the borrower(s) (including borrower’s income) relevant to making a credit decision. In particular, income of the borrower is money that a borrower or a business receives in return for working, providing a product or service, or investing capital. Further, age of credit or length of credit history may be referring to how long any account has been open. In addition, the outstanding debt is defined as the total principal as well as interest amount of a debt that has yet to be paid, which is of core importance for any company which has used debt financing. The outstanding debt is important because it expresses a dollar amount to be paid before a liability is closed. Further, historical payment performances refer to the pattern or the percentage of payments made in the past, related to the borrower. Furthermore, the asset recovery value is the projected value of an asset that can be recovered in the event of liquidation or winding down. The asset recovery value is calculated as the recovery rate times the expected recovery value of the asset.

Some methods for establishing and/or adjusting credit offers can be suboptimal when lending to a Contractor in a commercial building situation. The Contractor is paid by the General Contractor who in turn is paid by the Property Owner. Thus, the repayment risk of the Contractor is tied to both the General Contractor and the Property Owner. Some processes for establishing credit offers evaluate factors related to the Contractor but do not asses risk related to the General Contractor or Property Owner. Therefore, there is a need for an improved system and method for implementing adjustments to financial instruments, particularly a method for using information related to the Contractor for adjusting a credit offer.

Further, a mechanic’s lien is a legal claim against a property may be used by the lender, in case the lender is not paid. The mechanic’s lien provides lien rights to the lender against the property as a security interest in case the lender remains unpaid. The mechanic’s lien enables the lender to enforce a foreclosure action on the borrower’s property and receive payment from the sale of the property. In the case of the government project, the lender can make a bond claim, which is a sum of money reserved to protect security against payment disputes on the project. Generally, the lien rights are available to the lenders who provide credit offers or materials for any construction project. These lenders possess the lien rights only by virtue of working on or contributing materials to a construction project. The mechanic’s lien is a powerful tool to claim the paid debt, however, the right of filing the mechanic lien gets expired in lack of opting the correct steps to preserve it. Since the mechanic’s lien requires the lenders to take specific actions disclosed in state law to preserve their lien rights. In case, the lenders fail to take the right steps at the right time, the lenders may lose their right to file a mechanics lien. Since, the process to preserve the lien rights is driven by very strict deadlines and sending the notices within the time frames are other required factors, skipping any step during the process may lead to loss of lien rights. Further, the presence of liens related to a contractor is a negative factor that would lower the credit offer of the contractor.

Some methods for establishing and/or adjusting credit offers can be suboptimal due to the narrow focus of borrow and asset attributes and no contribution of lien information of the contractor or the borrower. Some financial instruments inefficiently evaluate the credit to be given to the borrower. Therefore, there is a need for an improved system and method for implementing adjustments to financial instruments, particularly a method for adjusting a credit limit based on lien data of the contractor.

Disclosed herein are systems and methods for contractor analysis. A system receives contractor information associated with a contractor. The contractor information includes financial information about the contractor and business information about the contractor. The system generates a contractor quality score based on the contractor information. The system establishes an account credit offer based on the contractor information, and adjusts the account credit offer based on the contractor quality score. Such systems and methods provide various technical improvements, such as improved accuracy in generating or adjusting a credit offer to an appropriate level for a given contractor and/or project, improved flexibility to accommodate contractors and/or projects of different types (e.g., including those that might otherwise be rejected), and/or improved efficiency to more quickly generate or adjust credit offers for contractors and/or projects by using trained machine learning models and/or other techniques described herein.

In one instance, a computer-implemented method for utilizing information related to a contractor to adjust a credit offer, the computer-implemented method includes the operations of acquiring contractor information, wherein the contractor information includes both financial and business information of the contractor, and information on a general contractor or property owner to which the contractor is connected; determining a contractor quality score based on the contractor information; establishing an account credit offer based on the contractor information; and adjusting the account credit offer based on the contractor quality score. In one embodiment, the contractor information includes contractor contact information and contract information of the client. For example, for contractor AB Flooring references to previous general contractors -James construction company (jconstruction@hotmail.com) and Bridging construction company (bconstruction@hotmail.com), financial related information – profit over last five years $3 million, expenses over last five years $9 million, and number of employees 50, and credit offers completed – L1 of amount $4 million with payment of full amount on-time, asking for an account credit offer of $90,000.

In one instance, the computer-implemented method for utilizing information related to a contractor to adjust a credit offer comprises creating a contractor’s profile including at least one of contractor’s name, address, website, client information, and financial-related information. For example, for contractor AB Flooring, including, address – 51 Kings street, Chicago, and CIN – 717, and previous clients as James construction company (jconstruction@hotmail.com) and Bridging construction company (bconstruction@hotmail.com).

In one embodiment, the financial related information includes at least one of historical revenues, historical expenses, historical profits, historical credit offers, payments history, open credit offers, capital equipment, number of employees, list of subcontractors, and client information. For example, for contractor AB Flooring, CIN – 717, and previous clients as James construction company (jconstruction@hotmail.com) and Bridging construction company (bconstruction@hotmail.com), profits of last 5 years – $3 million, expenses of last 5 years - $9 million, and number of employees – 50, and credit offers completed – L1 with a total amount of $4 million and fully paid amount of $4 million on time. In one embodiment, the client information may include client contact information and contract information of the client.

Further, the contractor quality score is based on at least one of a revenue growth score, a capital equipment score, quality sub-scores, quality percentage, credit offers completed, and credit offers related information. Further, the contractor quality score is converted to a quality percentage as a function of the base interest rate. In one embodiment, adjusting the account credit offer is based at least on one of the contractor quality score, a credit term, and a base interest rate. For example, if the revenue growth score is 10 through 7 and capital equipment score is 10, then contractor quality score – very high. In another embodiment, if the revenue growth score is 5 and capital equipment score is 10, then contractor quality score may be considered high. In another embodiment, if the revenue growth score is 3 and capital equipment score is 10, then contractor quality score – high minus. In another embodiment, if the revenue growth score is 0 and capital equipment score is 10, then contractor quality score – medium.

In one embodiment, the contractor information is stored in a contractor database. Further, the contractor database comprises details related to contractor Barrie Drywall, including CIN – 623, and previous clients as Rogers construction company (rconstruction@hotmail.com) and Golden construction company (gconstruction@hotmail.com), profits of last 5 years – $6 million, expenses of last 5 years - $7 million, and number of employees - 40, and credit offers completed -L2 with a total amount of $4 million and fully paid amount of $4 million on time and L3 with a total amount of $7 million and fully paid amount of $7 million, paid late.

In one embodiment, the contractor information includes information on a general contractor or property owner to which the contractor is connected. For example, for contractor AB Flooring, they are presently hired by general contractor Golden construction company for a commercial construction project owned property owner 123 Main St. LLC. Contractor information includes the real estate value of the 123 Main St. property, the value of the construction project, and the history of lien activity related to general contractor or property owner.

General Contractor: A general contractor in commercial building development is a person, party, or organization which provides resources or services such as labor, material for completing a project, on a contract basis. The contract may be defined for a pre-defined scope and a certain price. Further, the contractor may be catering to multiple clients at the same time and may have a financial history and business history based previous contracts.

The contractor is responsible for the overall management of the project. The contractor may make use of bids for acquiring the project in the first place. Further, the contractor is accountable to any profit from the contract work. The contractor forms an agreement with the Property Owner. The contractor may also contract with subcontractors that are necessary to complete the project.

Contractor: A Contractor sub-contractor in a commercial building development is a person, party, or an organization which is hired by a general contractor of the commercial building development to perform a specific task associated with the building development. The Contractor is liable to the general contractor and is hired when a specific task requires certain set of skills or specialization. An example is a flooring company (contractor) will be hired by the general contractor to install a gymnasium floor for a new high school. The contractor purchases material, coordinates logistics with general contractor, submits material detail logs to general contractor for approval, provides labor to install the floor, quality checks the installation and provides a warranty to the general contractor for the performed work.

The contractor may be responsible for completing a specific portion of the contract, based on particular set of skills of the contractor. For a single project, multiple contractors can be hired by the general contractor for different tasks. The contractor forms an agreement with the general contractor and not with the property owner. The contractor may be in contact with a network of general contractors.

Contractor profile: A contractor profile represents professional achievement, with roles and responsibilities, of a specific contractor during the execution of different projects undertaken by the contractor over a period of time. The contractor profile includes data and documents referring to various activities associated with the project(s) and also contains general information such as contacts, telephone numbers, email addresses, etc. and specific information related to the contractor.

The contractor profile is mostly open to public access and ensures transparency. Any normal person can view or check the contractor profile via the internet and can decide to select or reject the specific contractor, based on their requirements. The contractor profile can provide various activities associated with the project(s) such as information regarding corporate values of the company, mission, experience based on the project, operations for client satisfaction, Labor resources, safety information, quality assurance program, design capability, Project Management and controls, Miscellaneous Maintenance, etc. undertaken by the contractor over a period of time.

Contractor revenue: Contractor revenue is the revenue generated against a contract undertaken by the contractor. The contractor revenue is also known as transaction price, which is defined as consideration, the contractor receives, in exchange for their services after the completion of a project on a reporting date.

The contractor revenue is dependent on multiple factors such as initial amount of revenue agreed for the execution of a contract or variations in the contract work, claims and incentive payments. The contractor revenue may increase or decrease by uncertainties such as cost inflation, penalties arising from delay etc. The uncertainties depend on the outcome of the future events. For example, the total contractor revenue comprised of revenues from the sale of recyclable materials less recyclables revenue payments or the total contractor revenue may also comprise of revenue received by the contractor for the sale of franchised materials or their resulting by-products.

Contractor expenses: Contractor expenses are the expenses incurred by a contractor during the interval between the execution and completion of a project. The contractor business expenses incorporate costs incurred during the daily course of the project. They can be applied to small projects and large projects. The Income statement is determined by the contractor expenses which is revenue to arrive at a contractor’s taxable total income and subtraction of business expenses. The contractor expenses are directly proportional to the cost inflation during the project completion time, and it may increase than what it was during the previous year(s).

The contractor expenses are related to the trade of the contractors. The contractor business expenses incorporate the company emergence, accountancy fees, business travel expenses and accommodation, postage and stationery for business, training which directly related to the business to upgrade their skills, business phone calls, and equipment or machine purchased for business purposes. The Internal Revenue Code (IRC) mentions the guideline regarding business expenses in its section 162. It includes all the expenses which are common in the business industry and necessary for business purposes. Several contactor expenses are fully tax deductible such as advertising and marketing expenses, a few legal fees, utility expenses, etc. while some are partially tax deductible.

Contractor capital equipment: The contractor capital equipment is the items a contractor acquires but does not consume during the normal course of business or execution of a project. The items include assets that are primarily used for construction purpose such as machines, large vehicles, tools, computers, etc. Capital Equipment Policy is considered prior to make a purchase.

The companies obtain capital items to handle the business and to earn returns from the assets. A Construction project has the right set of equipment to get the job done. Getting the perfect equipment for each work helps with efficiency, safety, and build quality. Some equipment has many uses, while others are specific to a task. The capital equipment is assets, the expenditure required to put the assets in place, and ancillary costs such as taxes, installation charges, duty cost, freight, and insurance cost. The fixed asset category is subdivided into Capital equipment that includes industrial machinery and tools, office tools, large vehicles for transportation, furniture, and others. All these items are appropriately chargeable to the capital account.

Credit offer for contractor material: A credit offer for contractor material is a credit offer taken by the contractor for procuring the construction materials. Such type of credit offer enables a contractor to pay for the project materials not from their own funds. Also, contractors get cash to pay to the material suppliers before they can get paid by their customers. Thus, the contractor gets ordered materials long before they actually start work on a project.

Contractors mostly depend upon construction material credit offers to cover material expenses and protect their cash flow position. There are many ways that contractors can fund their material purchases through such credit offers such as trade credit, bank credit offers, supplier financing, and credit cards. Contractors open trade credit accounts with their material suppliers and avails the flexibility to delay payments for a certain period of time. To apply for bank credit offers, the contractors are required to provide audited financial statements that shows their business stability and success. Many contractors also use credit cards to purchase materials for their projects and pay the credit card company back according to the terms of the agreement which depends upon their credit score.

Credit offer – credit offer covered by materials: The credit offer is a type of credit offer covered by materials in the form of a credit card or credit offer to the contractor. The credit offer structure is covered for the material that depends on the project’s cash flow for repayment, with the project’s assets, rights, and interests. The Credit offer is also defined as offers provided by a ledger, such as banks, to the contractor for the material purchase.

Lenders may determine the type of credit offers, such as a cash back credit card or low interest credit card, based on the requirement. All such offers are governed by various acts such as the Fair Credit Reporting Act (FCRA). Contractors are provided with flexible credit offers based on their requirements. The terms offered for such credit offers depend on whether the credit offer from the lender is preapproved or prequalified. Preapproval is when a lender pre-screens a contractor and independently determines whether they meet their requirements for credit. If they meet the requirements for credit, then the lender sends a preapproved offer. Prequalification is when the contractor agrees to provide their credit information to a lender. Prequalification does not require a firm offer of credit.

Credit offer interest rate: The Credit offer interest rate is the rate at which a credit offer borrower is charged on the principal amount borrowed from a bank or a lender. Thus, the credit offer interest amount depends on the percentage of the principal amount borrowed from the bank or the lender. The annual interest rate applied on the sanctioned amount is termed as annual percentage rate (APR). The rate of interest is the effective rate for the borrower for credit offer and rate of return to the lender.

Some mortgages utilize simple interest, however, other utilize compound interest, which is applied to the principal and to the accumulated interest of prior periods. The credit score of an applicant is a primary factor to decide the interest rate by lending institutions. Other factors which impact credit offer interest rates are nature of employment or business, age, income etc. The income of the borrower determines their capacity to repay the credit offer. A borrower with a higher income has a better financial bandwidth to repay the credit offer on time. Also, the risk level for such type of borrower is low and lenders may prefer such borrowers with low-risk profiles and hence they offer you a lower interest rate.

### Credit Offer Term

The amount of time a lender gives to a borrower to repay the sanctioned credit offer is called the Credit offer term. It defines the repayment time period and various factors associated with the credit offer such as rate of interest, penalty fees (in case of delayed payment) depending upon this time period.

In return for a specified amount of money, the borrower accepts to a certain repayment plan with a fixed or floating interest rate. The credit offer is repaid by the borrower in regular payments over a set period of time. The period of time can be decided by the borrower which can last between one year to as long as 30 years in some cases. The borrower repays the credit offer amount with monthly or quarterly repayment principal and interest amount. The credit offer needed collateral and a rigorous approval procedure to minimize the risk of default or failure to receive the payments. Term credit offers normally carry no penalties if they are paid off prior of scheme time period. The credit offer team can be subdivided into short term credit offer, long term credit offer, and intermediate term credit offers. Example of Credit offer term, The Guaranteed credit offer which is also known as Small Business Administration (SBA) credit offer provides long-term financing. Short-term credit offers and revolving credit lines are also accessible to help with a company’s instant and cyclical working capital requirements.

Contractor portal: A contractor portal is a virtual platform, used by a contract company or a person, to manage instructions and information that abide by organizational rules or customer requirements. The portal enables a user to register themselves based on different roles such as an administrator or customer. The users may access and navigate the portal based upon the login privileges assigned to them during registration.

The contractor portal can be used by various entities such as construction contractor, employer’s contractors (HR firms) or any other entity which either hires or get hired on contractual basis. Such portals help the contractor to keep records of all the data related to their contract and make it accessible to all the stakeholders of the contract. The portal also provides the current information about the sources of supply and services to contract personnel.

Cloud: A cloud is a remote data storage system that logically stores the data. The data is stored in different physical storage servers, which are managed and owned by different entities. The owners of the cloud infrastructure are paid for the services they provide. The cloud can be accessed either through a collocated cloud computing service or by a web service application programming interface (API) or by applications that use the API which can be a cloud desktop storage, a cloud storage gateway or Web-based content management system.

A cloud can be used to store personal as well as public data. There is a default limit on the data storage depending upon whether the storage is for personal use or public use. The cost for securing the data stored in the cloud is always high because of the data being stored is in a distributed manner. The data is replicated and moved very often for security purpose so that no one can physically breach the data.

Computing device: A computing device is a multitasking device that consists of different elements. Such devices are capable of communicating with each other either directly or through a network. The computing device is used to carry out different functions such as a sequence of arithmetic or logical operations without human interference. Electronics devices take the input from the user, process the inputs, and calculates the output from the input. The mathematical devices which perform the calculations on the streams of binary format and equipment are controlled by the Central processing unit which has different software to perform different functions.

A computing device such as a PC, laptop, smartphone, or tablet is used by every individual and organization. The use of computing devices is vast, and its functionality fits in all the organizational work. The computing devices run on different operating Systems (OS) that makes them dominant in the surrounding. Several computing devices and peripherals perform data transfer by using infrared signals such as the signals used by a TV remote control device. Several laptops are equipped with IR transmitters and receivers for data transfer. Computers are used as a control system in several industries such as industrial robots and computer-aided designs. The computing devices have different configurations, models, designs, shapes, textures, weights, temperatures. The computing device has Internet connectivity and also have different software to perform connectivity between different devices to share information.

Network interface module: A network interface module (NIM) is an intermediate block that can be either hardware or software within an environment of a device. The module receives an incoming signal, such as RF (Radio Frequency) signal or HD (High Definition) signal and converts the received signal into a format that is understood by the device. Interface modules associate electronic devices with electrical systems at the control level. The module efficiently optimizes and manages the virtual network deployment. These modules are simply integrated into present architecture and hardware.

Routers and Ethernet LAN (Local Area Network) Switch are an example of network interface modules and are used for distributing consolidated virtual network traffic to a number of computing devices. Network Interface module can run on the central server based on the LAN/WAN (Wide Area Network) flexibility and availability. It controls a subset of main databases related to the site it controls. Several Network interface modules can connect and transfer data between multiple devices and the central server utilizing Ethernet and Transmission Control Protocol 9TCP+) /Internet Protocol (IP)protocols.

Processor: A processor is an integrated digital circuit, used for performing and processing instructions of a user. The processor is responsible for carrying out all the input and output duties of devices such as computers, laptops, smartphones, etc. The functionality of the input and output devices is dependent on the performance of the processor. The processor executes a variety of functions on the data stored in the memory or the data input by a user or data retrieved from outside digital sources.

A processor is made up of four units namely Arithmetic Logic Unit (ALU), floating-point unit (FPU) registers, and cash memories. All the units’ function together and give desired output depending upon the type of input/instruction(s). There are many different types of processors such as central processing unit (CPU), Graphics processing Units (GPU), etc. The primary functions performed by the processor are fetched, decode, execute and write back. The basic elements of a processor are the arithmetic logic unit, floating point unit, Registers, and L1 and L2 cache memory. Processors can be multicore, for instance where integrated chips (IC’s) consists of two or more processors for strengthening its performance, reduction in power consumption, and processing of multiple tasks simultaneously.

Display: A display is an output device, used to present information such as visual data including graphics, text, and numerals. The display includes a screen or a projection surface on which the information is produced. It provides man machine interaction in electronic devices such as computers, laptops, smartphones, Television set, Head-mounted displays, Heads-up displays, Virtual reality headsets, Broadcast reference monitor, medical monitors, Video Walls, etc.

Displays are also called Video Display Terminals or monitors. The input data of display is generally a character map or Bitmaps. Displays are made up of cathode ray tubes (CRT), light-emitting diodes, and Liquid crystal display. A display device usually consists of a visual display, several circuitries, a cover casing and a power supply. Some of the features of the display are ultra-wide screen, touch screen, Indicator light, and Power saving. The performance measurement of the display device is based on the display size, color characteristics, Aspect ratio, Resolution, Gamut and Input speed characteristics such as refresh rate, response time, and input latency.

Contract or agreement: A contract or agreement is a formal legal binding agreement that governs the rights and duties between or among the organizations or parties. The elements of a contract are offer, acceptance, intention to create legal relations, consideration, and legality of both form and content. When one of the parties in the binding agreement fails to deliver according to the terms of the agreement, the contract is breached, and the parties involved can resolve the problem among themselves or in the court.

A contract is enforceable by law when it meets requirements of the agreement, consideration, contractual capacity and law object. Contract limits the ability to bargain because of some legal restrictions. Contracts are of two types; one is called bilateral and other one is called unilateral. A bilateral contract is an agreement in which each party of the contract makes a set of promises to each other whereas the unilateral contract is an agreement in which one party makes a promise, but the second party does not promise anything to the other party.

Good standing: A person or an organization in good standing compiles with all explicit obligations, while not being subject to any form of sanction, suspension or disciplinary censure. Good standing of a company or an organization is proved by a legal document which is as per the laws of a specific state. The document proves that the company does not owe taxes and permit it to do business in a particular jurisdiction officially. A good standing can be used as a condition to help prevent fraud applications for necessary information or documents.

A good standing certificate proves that the entity or organization has paid all the fees and filed all the important reports. It is a type of certificate which is required by the organization to transact business in states other than their home state of registration. The certificate also has an expiration date which comes when the registration is due to be renewed or is due for a periodic maintenance fee.

Notification for payment: Notification for payment is a process to automatically keep track of purchase or transaction in real time. Payment notification can be messages of payment success or payment failure or current status of a payment. An automatic backend function keeps track of the information related to order tracking, customer payment and accordingly provides notifications related to the acquired services or transactions.

For example, an e-commerce software may record the information about the payment transactions through a payment gateway. Further, when the invoice is requested from the payment gateway, a payment notification message is sent to the E-commerce software from the payment gateway for successful or incomplete transactions. Further, the information on the contract payment notification includes details of the subcontractor, details of the contract and a declaration that the contract is not a contract of employment. Before a payment is made to the subcontractor, revenue of the gross amount of the intended payment is always notified.

Notification that lien will be filed: The notification that lien will be filed is also referred as the notice to intent to lien (NOI). The NOI gives warning to the property owner or other party that a bond claim will be filed unless the payment of the overdue amounts is made within a certain period of time. The notice of the intent to lien could be a replacement for a demand letter.

In state, federal and other public works projects, there is no requirement for NOI. It is often useful to send the Notice of Intent to encourage the parties so that they can make payment to avoid facing lien claim. A notice of intent to lien can be a replacement for demand letter and have the extra benefit of being relevant to parties other than the debtor. The notice of intent to lien document notifies the key project stakeholders about a payment problem, they may not foresee, and it also gives other stakeholders an opportunity to resolve the problem before a more adversarial lien claim is filed.

Notification of a property lien: Notification of a property lien is a legal claim on the assets where a creditor will seize the property and give notification to the debtor. The holder or the creditor gains access to the property if the debts are not paid. Since lien is a public record and is generally filed with a state agency.

A notification is attached to an individual property in case of any default by the debtor. In such a situation, the creditor can file a case against the debtor and receive approval for the property lien through government or state agencies. The property lien includes repossession of real estate property or equipment. It is the final operation taken by a creditor against the debtor for collecting the unpaid debt.

List of building materials: List of building materials are the list of raw materials used during the construction of a building. Such list of materials is also known as construction material list. Cement, steel, sand, concrete, ready-mix concrete, binding wires, aggregates, bricks, blocks, etc. are few examples of building/construction materials. Building material have different properties such as weight, strength, durability, and cost which makes these materials suitable for various construction activities.

The building materials are selected precisely ensuring the protection and long life of the building. The materials and products are used by construction project managers or contractors for completing undertaken construction projects. Building materials are naturally occurring materials or may be manufactured products i.e., some are more synthetic, and some are fewer synthetic materials.

Lien History: A lien history is a history of legal rights against assets that are used as collateral to satisfy a debt. The lien history is established by a creditor or a legal judgement. It forms security interest that is granted over an item of property to secure the payment of a debt. Depending on the history behind the lien, the liens are referred as part of the process of purchase and may not be considered as a deal breaker.

Liens are of two types i.e., Personal liens or corporate liens. The difference between both the liens is that the corporate lien can become a type of investment whereas the personal lien cannot be considered as a part of investment. Further, liens can be consensual or non-consensual. Consensual liens between the creditor and the debtor are imposed by a contract whereas the Non-consensual liens are imposed by statute or by the law.

Underwriting process: Underwriting is a method through which an individual or institution takes financial risk, such as taking a credit offer in lieu of premium, insurance, or investments for a fee. Underwriting helps to place fair rates for borrowing in credit offers, establish appropriate premiums, and develop a market for securities by accurately pricing the investment risk.

The underwriting is a key function in financial world. An underwriter is an individual that sells the minimum number of securities of a company for commission. There are three types of underwriting i.e., credit offers, insurance and securities. A human underwriter is required for mortgage credit offer underwriting. The policyholder is the main focus in insurance underwriting. Securities underwriting assess risk and the appropriate price of securities such as IPO.

Project credit offer: A Project credit offer is a credit offer structure that depends on the project’s cash flow for repayment and takes into account the project assets, rights, and interests. The project Credit offer is also defined as offers provided by a ledger, such as banks, to the contractor based on the project. Project credit offer is used to fund long term projects. They are usually non-recourse credit offers, which are protected by the project assets and repayment of the project is done by the complete cash flow of the project.

The offer includes the build, operation, and transfer (BOT) of the projects. Project credit offer provides off-balance-sheet financing of the project. The project risk is shifted to lenders in exchange for which the lenders obtain a higher margin for lending. Project financing offer is more complicated and alternative financing methods to attract borrowers for its project by offering special credit offers based on its project. These offers can change with respect to time by the financial institutions as per their credit policies.

Account credit offer: Account credit offer is defined as offers provided by a financial institution, such as banks, against a customer account. The account credit offers are sent to a user for rejection or acceptance by any suitable means such as a text message and/or via telephonic call.

These offers are customer and bank oriented for e.g., different banks provide different account credit offer to different customers depending on the transaction activities of the customers. The account credit offer depends on lenders to determine the type of credit offers, such as a cashback credit card or low-interest credit card, based on the account activity and requirement of the user. All such offers are governed by various acts such as the Fair Credit Reporting Act (FCRA). These offers are subject to change with respect to time on the basis of the transactions done by the customer against their account. These offers are defined as per the financial institutions and on its policies towards customer accounts.

Account credit: The account credits are an accounting activity in which money is credited to the account. All accounts that contain a credit balance will increase in amount when credit is added to them and reduced when a debit is added. The category of accounts to which this rule covers are liabilities, revenues, and equity. The credit may also be in the form of rewards.

For example, the rewards or cashback received by a user of GPay, Paytm, Paypal or Phonepay is a type of account credit because cashback is reflected in the customer’s account. The cashback can be used as a normal currency for purchasing any kind of goods and services. The account credit can also be in form of contract agreement between the borrower and the ledger in which the borrower receives credit in the form of money from the ledger and repays at a later day with interest. The individual or company that provides credit is termed as the creditor. Credit is provided in exchange for a product or service given by the creditor to the account holder.

Account credit limit: The account credit limit is defined as an upper limit of credit associated with an account as extended by a creditor. The account holder, or customer, is free to withdraw any amount up to and including credit limit from the concerned account. The credit limit, linked to a customer, is based on customer’s credit score, and may also impact their ability to get the credits in the future.

A customer applies for a credit in form of either a credit card and/or credit offer. The lender, which may be any financial institution, evaluates risks associated with the customer based on multiple factors such as spending habits and credit score. Based on these factors, the lender set an upper limit on the credit that the customer may utilize without any adverse effect. If the borrower spends more than the credit limit, then the borrower is fined and is required to pay the penalty in addition to their regular payments.

Real estate owner: A real estate owner is defined as a legal entity whose ownership of any real estate or property is recognized by the law of the land. A legal entity can be either individuals and/or organizations. A real estate owner has the ultimate control and right to use the property as long as the law permits. A real estate owner can be categorized in different types i.e., Individual Ownership or solo ownership, Joint or Co-ownership, and property ownership by nomination.

Any constructor or a potential buyer contacts the real state owner with a contract or lease proposal to accrue the real state property. It is up to the owner to accept or reject the proposal. Further, it is the responsibility of real estate owner to pay taxes on all the real estate they own. A real estate owner always has the ultimate responsibility for the maintenance and repair of the property. A real estate owner can transfer the property without any limitations. One can become owner of real estate by acquiring legally from previous owner, either in exchange for money, or as gift or donation.

Payment credit offer schedule: The payment credit offer schedule is defined as the schedule according to which a credit offer must be repaid by the borrower. A credit offer is repaid in multiple instalments, each paid at a fixed interval of time. The schedule of fixed time intervals on which the instalments are paid is called as payment credit offer schedule.

Generally, the instalments are paid monthly and are commonly known as EMI. However, based on agreement of between lender and borrower, the instalments can also be paid quarterly, half yearly or annually. Instalments paid monthly are called EMI or equated monthly instalments. Instalments can be paid with fixed or variable rate of interest amount. Further it depends on the schedule of instalments. The payment credit offer schedule is important to the borrower to understand the credit offer repayment by breaking down the balance into equal monthly EMIs and also help borrower to calculate the total interest payable on the credit offer. The repayment schedule of the credit offer amount is the full list of that borrower is required to pay toward interest and principal over the period of the credit offer. The payment credit offer schedule is calculated based upon type of interest that is fixed rate of interest and variable rate of interest. During fixed rate of interest payment schedule remains fixed while during variable interest rate amount of payment of credit offer changes which also impact repayment schedule of the credit offer.

Credit limit: The credit limit is defined as a maximum amount of credit that can be used by a customer extended to them by a financial institution such as bank. The credit limit for a specific customer is based on customer’s credit score and may also impact their ability to get credits in the future. Through the good credit score, it will affect the ability to get financing things like a car or start a business. The credit limit can also depend on the customer income.

For example, based on the customer credit score, one user may have one credit limit while the other user may have a different credit limit. The credit limit can be adjusted by the credit card issuer, if the customers are using the card wisely, for example, if the customer consistently made payments on time, the bank may increase the credit limit on customer current card because customers are considered less risky of a borrower to credit offer more money.

Insurance companies that insure against building material credit offers: The insurance companies that insure against building material credit offers are the companies which offer an insurance policy for the credit offers taken by the contractors to complete undertaken project. Sometimes, to procure building materials for construction of the building, the builder may need a credit offer. An insurance policy for building materials covers potential losses of builder during the construction phase of the building.

The building material credit offer helps contractors get money/finances to pay for their materials using cash received from bank. The insurance company that ensures building material credit offer check the signed document paper of contractor or builder and the documents include the budgets assigned to each portion of the project, building materials to be use and plans approved by the municipality. Further, if any chance the building materials gets damaged by fire, lightning, explosion, earthquake, and storm damage the risk Insurance Cover all.

Lien: Lien is defined as a legal right to keep possession of the property or real estate belonging to someone else until they have repaid all the debts. The lien is created by a creditor or legal entity and is mostly used to recover debt. When a borrower does not pay his mortgage or neglects to pay income or property taxes, a lien may be placed against his property as a way for the lender or the Internal Revenue Service to try and recoup what is owed to them.

The lien guarantees an underlying obligation such as repayment of credit offer. In case of failure of payment of the credit offer, the creditor or legal entity may seize the asset that is the subject of the credit offer. The lien may arise by the agreement of the parties, by the general usage of trade and by particular usage of trade. A lien can only be released by the organization or person who created it. However, some actions can take may release the lien including like, paying off the lien, settling the lien, correcting the lien, disputing the lien.

Liens - state laws: Liens state laws refer to different laws or guidelines set by different states concerning lien. Depending on the state, timelines for lien may change and therefore location of property should be kept in mind when initiating lien process. Different state liens laws have different timelines. In some states the lien of a properly docketed judgment affects all the debtor’s property in every county where notice of the judgment is filed.

Where the contractor wants to work in a particular jurisdiction, they need to take measures of all the requirements by the Liens - state laws. The contractor should be aware of all the liens laws in that particular jurisdiction. A notification of a particular contractor working on a site should also be provided by the contractor to the government. The timelines of state lines laws can affect when you need to let the owner know you’re working on a project.

Liens - federal laws: Liens federal laws are laws and guidelines regarding lien defined by the federal government. The federal law always controls federal lien property cases. A federal lien is the government’s legal claim against your property when you neglect or fail to pay a tax debt. The government points out that a matter of federal law as to whether a lien created by a state statute is sufficiently specific. A federal tax lien records subsequent to an attachment lien, but prior to the date, the attaching creditor obtained judgment.

The federal law requires certified copy of the abstract of judgement and automatically creates lien on property or land in the state within district where court is situated. The federal court created judgement lien lasts for 20 years. Also, most of the states follows the 20 year20-year rule but not some may not. The uniform Federal lien registration act provides for the registration of federal lien by procedures consistent with normal recording of mortgages in local area property records with the normal filing of security interest of personal property.

Specific actions to preserve their lien rights module: Lien is defined as a legal right to keep possession of the property or real estate belonging to someone else until they have repaid all the debts. The action to preserve the lien is to register the lien in the land registry office with the cost of land which the owner is claiming to be owed. Lien rights just by virtue of working on or contributing materials to a construction project, the right to lien will expire without the correct operations to preserve it.

Few operations such as sending notice, filing liens within a given time frame are to be fulfilled in order to preserve lien rights. Generally, direct contractors, subcontractors, material suppliers, equipment lessors, design professionals (architects and engineers), and laborer all have lien rights. A lien is a legal claim on the property title, which is very difficult to get rid of without paying the debt right. The lien rights help reduce financial risk for contractors, subs, and suppliers, all of whom are required to put up significant sums of their own money in advance.

Public or private rights module: The public right module deal with the social problems in the broad conditions and it includes constitutional law, administrative law, criminal law, and criminal procedure law. Rights that deal with public rights are permanently applicable to the state. It depends on the structure of the government. The private right module deals with situation influencing private individuals and corporations. Private rights depend on the substantive and legislative regulation governing relationship in-between individuals.

Private rights can be found in between organizations and employment. For example, the rules of behavior established by an employer. Subdivision of private rights are contract rights, law of torts, Property rights, Labor rights, Commercial rights, Corporations rights, Competition rights. Public rights are circumstances involving public bodies. Normally, public bodies and government officials get their authority to construct decisions and to take embodiment in the form of legislation.

Sending preliminary notice module: The sending of preliminary notice module is defined as sending a notice by a legal entity at the start of their work on a construction project on the real estate. The preliminary notice is required in order to protect right to file a mechanics lien or a bond claim in case the contractor or equivalent party is unpaid. A preliminary notice is a routine letter notifying the property owner of work on the project. Preliminary notices are an opportunity for contractors to introduce themselves to property owners and describe the services or supplies they plan to provide, encouraging transparency in their working relationship with the owner.

The preliminary notice may also be known as NTO (notice to owner), notice of furnishing, prelim, prelien etc. It provides information regarding the company, the work, or materials that the company is providing to the project, and the amount you anticipate being paid for the contributions. Subcontractors who provided professional services, materials, or equipment are required to send preliminary notice to the property owner 60 days from first delivering materials.

Sub-tier parties to send one notice module: The sub-tier parties to send one notice module is defined as sending, by the sub-tier parties like sub-contractors and suppliers, a notice to the main contractors and/or owner regarding their work and contribution and in order to file mechanics lien on construction projects.

The sub-tier parties should send notice for each project in order to get paid timely and move on another project. By sending the preliminary notices helps the sub-tier parties. Further, it brings the attention of the owner. However, Owners have the knowledge of particular companies working on their property. So, they can collect what they owned. Sub-tier parties send notice module make the time management better.

Notice of intent lien (NOI) module: The notice of intent lien is a notice defining consequences of non-payment. Using this, owner, main contractor and/or any other party is warned that mechanics lien or bond claim cannot be filed until / unless payment is made in a given time period. The notice of intent works as a demand letter. The Notice of Intent is the equivalent of a demand letter in a civil case and is generally considered the second operation in the procedure for obtaining a lien, just before the formal filing of a lien claim with the court.

The notice of lien becomes ineffective as of the date all charges are paid in full. The notice of intent to lien tool is a kind of pressure release valve for the construction industry, which is popular for payment abuses, delays in work, and challenges regarding working capital. Notice of Intent lien documents typically produce better and faster results with contractors seeing payments an average of 20 days later.

Deadline module: Deadline module is defined as the module that has information about the completion time of every activity involved in a construction project. The owner of each project activity can plan their sub-activities as per the deadline mentioned in this module. Lien will not attach to property and is not enforced unless you have filed a lien within 90 days of deadline module.

The deadline module helps all the parties involved in a project keep track of timeline and anticipate any upcoming delays. Every state has their own specific notice deadlines module and form requirements. Even states that use the same name for preliminary notices vary greatly in their application. Each state has their own statutes that govern the rules and deadlines module for sending notice to protect payment.

Credit offer Appraisal: Credit offer appraisal is the specific credit offer application or proposal to assess the repayment capability of the credit offer applicant. A lender manages a credit appraisal chiefly to construct rules that to increase the probability that the lender gets back its money. Appraisal of credit offers requires a dynamic approach involving, inter alia, a projection of future trends of output, sales, and estimates of costs, returns and flow of funds. There are four broad aspects of credit offer appraisal, namely, technical feasibility, economic feasibility, managerial competence and financial or commercial feasibility.

The credit offer appraisal process checks financial elements, management, market, and other financial details of the credit offer applicant. All the banks and non-banking financial corporations (NBFCs) make use of a credit appraisal policy prior to approving any credit offer application. Each lender will have its own process for performing credit appraisal procedures to assess the credit worthiness of a particular credit offer applicant. The credit appraisal is performed to avoid the possibility of default on credit offers.

Credit offer Equity: Credit offer equity is defined as consolidating high-interest debt at a lower interest rate. With equity funding, money is raised by selling a portion of ownership in the company. Equity credit offer amounts depend on the difference between a current market value and the mortgage due balance. An equity credit offer is the credit offer that is available to you against the equity on a property. A type of consumer debt, home equity credit offer is also known as an equity credit offer, a second mortgage or a home-equity instalment credit offer.

Equity is the difference between the present cost of property and the mortgage owed by the owner. An equity credit offer works similar to a home credit offer, both cases the home serves as collateral. However, for a home credit offer, the eligible credit offer amount is up to 90% of the market value of the house. The fastest way to build equity is to come up with a large down payment, the larger the down payment, the more equity immediately have in home.

Promotional Annual Percentage Rate (APR): Promotional annual percentage rate is the APR of a credit card offered under promotion. Credit card companies charge interest on outstanding balance at the end of billing cycle. Rate of this interest is when annualized is known as APR. A very low APR, when offered as a promotional scheme, is called Promotional APR. The annual percentage rate or the interest rates are normally set high as a short tenure restricts lenders from making adequate profits.

The ledger decides the timing of the promotional rates. A zero percentage of promotional APR may cover to a card’s purchase APR or balance transfer APR or both. It mainly dependent on the offer provided by the ledger. For example, if the ledger offers in the card a zero percent promotional APR for both qualifying purchases and balance transfers, the card holder won’t have to pay any interest on qualifying purchases or balance transfers during the offer time period.

Contractor credit score: Contractor Credit score is defined as a credit score assigned to a contractor by credit bureaus. This is a measure of contractor’s payment practices. Contractor Credit score indicates whether the contractor has a history of paying their bills on time, or if they are slow payers. Further, this score is also used when a contractor applies for a credit offer or line of credit.

The construction credit offers for business or a contractor line of credit depends on a multiple of elements that need to need to be contemplate, including lender requirements, types of credit offers, and contractor credit score. The lenders use the contractor credit score of an individual contractor to identify whether credit offer should be given to a contractor or not and if yes, then what amount can be given as a credit offer to the contractor.

Short term credit offers: A short-term credit offer is a type of Credit offer which is obtained for a short period of time. A business generally takes a short-term credit offer in order to tide over cash crunch in present with a future payment in sight. A short-term credit offer is a type of credit offer that is obtained to support a temporary personal or business capital need. Short term credit offers provide quick cash when your cash flow is lacking, have shorter repayment periods than traditional credit offers.

A prominent example of a short-term credit offer is the products/ services purchased with the help of credit cards on EMI. Short term credit offers generally carry a higher rate of interest. Examples of short-term credit offers includes, Overdraft, credit card, Payday credit offers, money market, refund anticipation credit offer, bridge credit offer. Many borrowers prefer short-term credit offers from a direct lender that eliminates any intermediaries such as credit brokers.

Long term credit offers: A long-term credit offer is a type of credit offer which is obtained for a long period of time. This period can be up to 30 years. It is mostly used in a financial industries or organizations with long term goals. For such credit offers the sanction is based on stable and regular income of applicant, future prospect and/or any collateral to be submitted. Long term credit offers are popularly taken from banks and other financial institutions.

Home credit offer, Student/ education credit offer, car credit offer etc. are examples of long-term credit offers as the repayment period is more than 3 years. Because of the longer tenure, the interest rates are lower, and many terms & conditions tend to be relaxed as compared to short term or quick credit offers these types of credit offers like education credit offers, car credit offers, home credit offers and certain kind of personal credit offers fall into this category. Benefits of taking a long-term credit offer are lower interest rate, maintain liquidity, flexibility, tax benefits, online application.

Line of credit: A line of credit is a facility provided by a financial institute. Instead of providing the full amount to customer at once, the full amount is stored in an account by the lender. The customer can withdraw any sum of amount, up to and including credit limit, if and when needed. The interest rate is paid only on the amount withdrawn. With a line of credit, a person may borrow as much or as little of the available credit as needed, and only pays interest and fees on that amount.

A credit card holder has a limit of credit available to them. It is not necessary for a card holder to withdraw all their credit once. Thus, a card holder has the provision of creating a line of credit according to their need. Another common line of credit is a home equity line of credit, it secured credit lines backed by the value of the borrower’s home, and generally carry low interest rates. Lines of credit are also extended to business owners.

Cash advance: A cash advance is defined as a type of short-term credit offer. Like all short-term credit offers, this also comes with high rate of interest but has advantage of quick approvals or quick funds. In cash advance an amount of money that someone borrows and on which they start to pay interest as soon as they receive it. Credit card cash advances usually come with high fees. A cash advance doesn’t directly affect credit score, and credit history won’t indicate the borrowed one.

As an example, cash withdrawn from an ATM using a credit card is a form of cash advance. For example, most credit cards let borrow a set amount of cash as an advance that can be pay back with interest, but generally, we can only borrow up to card’s cash advance limit and not full credit limit. When take a cash advance, it gets added to credit card balance and accrues interest until its repaid just like purchases and balance transfers do.

Factoring credit offer: The factoring credit offer is a method used by the organizations to raise capital. In a scenario when an organization is in need of capital, but invoices raised for its customers are still being processed, the organization may take a factoring credit offer from a lender using invoices as collateral. In such a scenario, the organization can raise capital up to 90% of invoices value. Financial institute receives payments made by the customers, deducts its fee and then releases rest to the organization.

A factoring credit offer is also known as factoring receivables and is an option for businesses that allow customers up to 3 months for payments. For example, if anyone want to expand business and need money in order to secure a bid for construction, then it can use factoring to get that money. Factoring companies do not take a large percentage of the invoice, a percentage upfront when they purchase the invoice, the rest of the money will come after they have collected, minus the fee they take.

Bankruptcy: Bankruptcy is a legal situation when an entity is unable to repay its outstanding debt. In such a case wherein, a debtor can’t repay off its debt, files for bankruptcy in the court of law which may declare the debtor as bankrupt or insolvent. The court then appoints agents who then take the control of the assets of the debtors and apportions it in ratio of the debt owed by creditors on a pro-rata basis. The debtor is then declared as debt free.

For example, when a contractor or a builder borrower some amount from the lender or the bank as its working capital and is supposed to repay the amount to the bank in certain period of time. If the contractor is unable to pay the credit offer in its specific time, then the assets are all sold for the recovery of amount. But if the amount to be recovered by selling all the asserts is not fulfilled then the person is termed as bankrupt.

Collateral: A borrower’s assets are referred as collateral when the borrower uses the assets as a security deposit to take out a credit offer. The assets are deposited so that if the borrower defaults on the credit offer, the lender can sell/ auction the asset after seizing it and recover a part or full value of the credit offer. Collateral is any property or asset that is given by a borrower to a lender in order to secure a credit offer. Collateral acts as a guarantee that the lender will receive back the amount lent even if the borrower does not repay the credit offer as agreed.

A collateral can be any type of assets such as piece of land or invoices of payments or the business or etc. For example, if a person wants to take out a credit offer from the bank, he may use his house property as collateral. If he fails to repay the credit offer, the collateral may be seized by the bank, based on the two parties’ agreement, if the borrower has finished paying back his credit offer, then the collateral is returned to his possession.

Personal guarantee: When a promoter/ executive/ director of a business makes personal legal promise that if the business fails to repay the credit in part or full, the individual will take the onus to repay the balance of the credit himself/ herself; it is termed as personal guarantee. It acts as an extra security for the creditor that safeguards its interest in the credit transaction.

Generally, when the amount sanctioned by the lender is big then the lender prefers to have both collateral as well as personal guarantee for its security. A personal guarantee can be anyone related to the borrower. It is not necessary to add a person in blood relation to the guaranteed list. Although it is necessary to get approval from the guarantee.

Business credit score: The business credit score refers to a number given by the credit rating agencies which implies that whether a company is fit/ creditworthy to service a credit offer or not or if they are fit become a business partner/ consumer. This score is obtained by analyzing the credit repayment history of the company and their relations with their suppliers and lenders. Multiple parameters such as liens, taxation history, legal proceedings, bankruptcies, longevity, business size etc. are accounted for before this score is given.

When a company or business wants to apply for a credit offer to fulfil its purpose, the Major criteria for getting the credit offer approved will be the business credit score. For credit offer approval, the revenue, profits, assets, and the collateral value of the purpose are required. The major credit scoring firms are Equifax, Experian, and Dun and Bradstreet.

Personal credit score: The personal credit score refers to a number (mostly between 500-850) given by the credit rating agencies (such as CIBIL, Equifax etc.) which implies that whether a person is fit/ creditworthy to service a credit offer. Higher is the credit core of a person, better are the chances of the person to obtain credit offer from lender. This scored is obtained by analyzing the credit repayment history of the person and their credit repayment behavior. The lenders use the credit score of individuals to identify whether credit offer should be given to a person or not and if yes, what amount can be given as a credit offer to the borrower.

When an individual applies for a credit offer to fulfil their purposes, the criteria which help them to get credit offer approval are the personal credit scores, assets, and income of an individual. It also helps the borrower to get the credit offer at the least rate of interest. For example, in personal good credit score, the person gets many benefits like cheaper to borrow money, best rates of cars, and homeowner insurance, and good rewards.

Ranges: throughout this disclosure, various aspects of the disclosed systems and methods can be presented in a range format. It should be understood that the description in range format is merely for convenience and brevity and should not be construed as an inflexible limitation on the scope of the disclosed systems and methods. Where appropriate, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range. “About” as used herein when referring to a measurable value such as an amount, a temporal duration, and the like, is meant to encompass variations of ±20%, ±10%, ±5%, ±1%, and ±0.1% from the specified value, as such variations are appropriate.

Referring now in detail to the drawings, in which like reference numerals indicate like parts or elements throughout the several views, in various embodiments, presented herein is a system and method for using a contractor quality score to adjust a credit offer.. Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

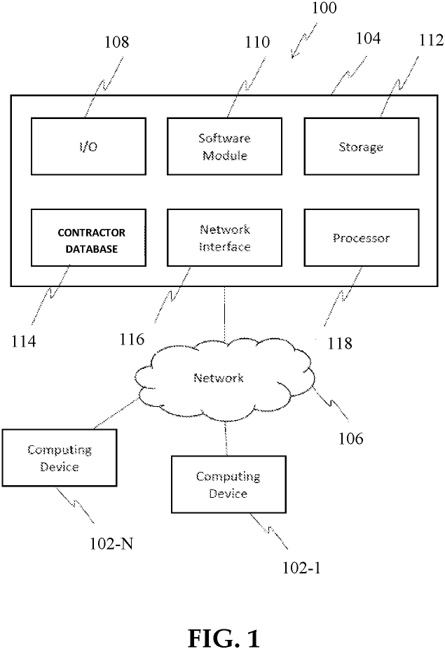

FIG. 1 illustrates a system 100 for using a contractor quality score to adjust a credit offer for a contractor, according to some examples. The system 100 may comprise one or more computing devices 102-1...102-N, a processing system 104, and a network 106. It can be noted that the one or more computing devices 102-1...102-N may be communicatively coupled to the processing system 104, via the network 106. It can be noted that the term contractor may be used interchangeably used as a user or a borrower or a client.

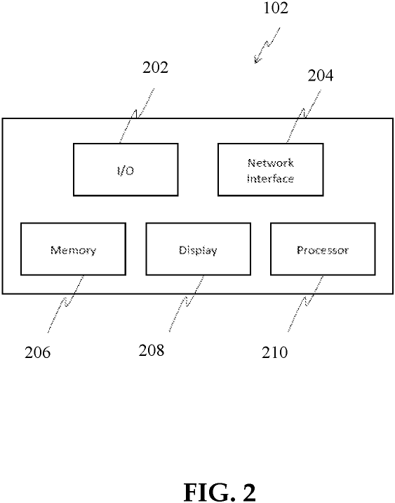

In one embodiment, the one or more computing devices 102-1... 102-N may be a computing device, desktop, laptop, smartphone, table, computer, smart speaker, smartphones, other wireless digital/cellular devices, or I/O devices. It can be noted that the one or more computing devices 102-1...102-N may be referred to as a computing device 102, hereinafter. The computing device 102 may comprise an input device and an output device. The input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. The output devices may include video displays, graphical displays, speakers, headphones, inkjet printers, laser printers, and 3D printers. Devices may include a combination of multiple input or output devices, including, e.g., Microsoft KINECT, Nintendo Wii mote for the WIT, Nintendo WII U GAMEPAD, or Apple IPHONE. Some devices allow gesture recognition inputs through combining some of the inputs and outputs. Some devices allow for facial recognition which may be utilized as an input for different purposes including authentication and other commands, devices allow for voice recognition and inputs, including, e.g., Microsoft KINECT, SIRI for IPHONE by Apple, Google Now or Google Voice Search. Additional mobile devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), or force-based sensing technologies. Some multi-touch devices may allow two or more contact points with the surface, allowing advanced functionality including, e.g., pinch, spread, rotate, scroll, or other gestures. Further, the computing device 102 could be an optional component and would be utilized in a situation in which the paired wearable device is utilizing the computing device 102 as additional memory or computing power or connection to the network 106. It can be noted that the computing device 102 may be used by system administrators, or by client users such as contractors, borrowers, and auxiliary users such as financial institutions and underwriters. It can be noted that the computing device 102 may be explained in conjunction with FIG. 2.

Further, the network 106 may be implemented for connecting the various devices in the system 100. Further, the network 106 may be coupled to the one or more computing devices 102-1... 102-N and the processing system 104. Further, the network 106 may be a wired and/or a wireless network. The network 106, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques, known in the art. The network 106 may allow ubiquitous access to shared pools of configurable resources and higher-level services that can be rapidly provisioned with minimal management effort, often over the internet and relies on sharing of resources to achieve coherence and economies of scale, like a public utility, while third-party clouds enable organizations to focus on their core businesses instead of expending resources on computer infrastructure and maintenance. The network 106 may also use standard architecture and protocols as understood by those skilled in the art, such as, for example, a packet switched network for transporting information and packets in accordance with a standard transmission control protocol/Internet protocol (“TCP/IP”). Additionally, the system 100 may utilize any conventional operating platform or combination of platforms (Windows, Mac OS, Unix, Linux, Android, etc.) and may utilize any conventional networking and communications software as would be understood by those skilled in the art. Additionally, the network 106 may be communicatively coupled to the one or more computing devices 102-1... 102-N and the processing system 104, to facilitate the system 100 for utilizing information related to a contractor to adjust a credit offer.

Further, to protect data of the borrower, such as sensitive user financial and personal identification data, government data related to the construction or site plans, other confidential data, and to comply with state and federal laws pertaining to the protection of financial and personal identification data, an encryption standard may be used to protect files from unauthorized interception over the network. Any encryption standard or authentication method as may used at any point in the system of the disclosed systems and methods. For example, encryption may be accomplished by encrypting an output file by using a Secure Socket Layer (SSL) with dual key encryption. Additionally, the system may limit data manipulation, or information access. For example, a system administrator may allow for administration of the system at one or more levels, such as at an individual reviewer, a review team manager, a quality control review manager, or a system manager. Further, the system administrator may also implement access or use restrictions for users at any level. Such restrictions may include, for example, the assignment of user names and passwords required for use of the system run a check for or to implement an adjustment, backend administrative access, associated mobile device apps, or the selection of one or more data types that the subservient user is allowed to view or manipulate.

In one embodiment, the processing system 104 may be used to implement the methods described herein that provide adjustments to a financial instrument to adjust a credit offer. Further, the processing system 104 may comprise an input/output (I/O) module 108, a software module 110, a storage module 112, a contractor database 114, a network interface 116, and a processor 118. The I/O module 108 may be used by a system administrator, which specialized access that can be used to adjust the credit offer. The I/O module 108 may comprise I/O devices, display devices, or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also allow storage and/or an installation medium for the computing device 102. In still other embodiments, the computing device 102 may allow USB connections (not shown) to receive handheld USB storage devices. In further embodiments, a I/O device may be a bridge between a system bus and an external communication bus, e.g. a USB bus, a SCSI bus, a FireWire bus, an Ethernet bus, a Gigabit Ethernet bus, a Fiber Channel bus, or a Thunderbolt bus.

Further, the software module 110 may be utilized to run a software or an algorithm, for performing a method for utilizing property criteria to enhance the credit offer of the borrower. The system 100 for implementing an adjustment may operate as application software, performed by the software module 110, which may be managed by a local or remote computing device. The software may include a software framework or application architecture that optimizes ease of use of at least one existing software platform, and that may also extend the capabilities of at least one existing software platform. The application architecture may approximate the actual way users organize and manage electronic files, and thus may organize use activities in a natural, coherent manner while delivering use activities through a simple, consistent, and intuitive interface within each application and across applications. The architecture may also be reusable, providing plug-in capability to any number of applications, without extensive re-programming, which may enable parties outside of the system 100 to create components that plug into the architecture. Thus, software or portals in the architecture may be extensible and new software or portals may be created for the architecture by any party.

In one embodiment, the system software may also be a portal or SaaS that provides, via the GUI, remote access to and from the system for implementing an adjustment. The software may include, for example, a network browser as well as other standard applications. The software may also include the ability, either automatically based upon a user request in another application, or by a user request, to search, or otherwise retrieve particular data from one or more remote points, such as on the Internet or from a limited or restricted database. The software may vary by user type, or may be available to only a certain user type, depending on the needs of the system 100. Users may have some portions, or all of the application software resident on a local computing device, or may simply have linking mechanisms, as understood by those skilled in the art, to link a computing device to the software running on a central server via the communications network, for example. As such, any device having, or having access to, the software may be capable of uploading, or downloading, any information item or data collection item, or informational files to be associated with such files.

Further, presentation of data through the software may be in any sort and number of selectable formats. For example, a multi-layer format may be used, wherein additional information is available by viewing successively lower layers of presented information. Such layers may be made available by the use of drop-down menus, tabbed folder files, or other layering techniques understood by those skilled in the art or through a natural language interface as described herein throughout.

Further the storage module 112 may be used store the software or the algorithm, for performing a method for utilizing project information to adjust the credit offer of the borrower. It can be noted that the storage module 112 may store one or more instructions and data. The data may be related to at least but not limited to agreement between lender and buyer, credit offer, lien documents or credit offer security documents. The one or more instructions may be instructions that are executable by the processor 118 to perform a specific operation for performing the method for utilizing project information to adjust the credit offer of the borrower. Some of the commonly known memory implementations may include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, cloud computing platforms (e.g. Microsoft Azure and Amazon Web Services, AWS), or other types of media/machine-readable medium suitable for storing electronic instructions

Further, the contractor database 114 may be used to store data related to the contractor, data related to the credit history, and current credit of the contractor. Further, the contractor database 114 may be configured to store a systematic collection of data used for electronic storage and manipulation of data. In one embodiment, the contractor database 114 may be of various types such as but not limited to centralized database, cloud database, and network database. The contractor database 114 may include structured data containing details of the users including the lender or the borrower and all other documents related to their agreement. In an embodiment, the contractor database 114 may include, but is not limited to, name and address of the lender and contractor, agreement terms and condition between the lender and the contractor, credit score, years in business, annual revenue, trade of contractor, payment performance of the contractor, average project score of the contractor, criminal history, civil judgements, outstanding debts, and lien history. It can be noted that the information stored in the contractor database 114 may reflect a robust picture of the contractor’s business and financial soundness. There are no limitations to the number, type or connectivity of the contractor database 114 utilized by the system 100.

Further, the system 100 may provide financial and site planning/progress software applications accessible to one or more users, such as different users associated with a user or a financial institution to perform one or more functions. Such applications may be available at the same location as the user, or at a location remote from the user. Each application may provide a graphical user interface (GUI) and the network interface 116 for ease of interaction by the user with information resident in the system 100 and for facilitating communication of the processing system 104 with the network 106. The network interface 116 may be specific to a user, set of users, or type of user, or may be the same for all users or a selected subset of users. The system software may also provide a master network interface set that allows a user to select or interact with the network interface 116 of one or more other applications, or that allows a user to simultaneously access a variety of information otherwise available through any portion of the system. Further, the network interface 116 may perform signal transmission and distribution functions within the system 100. The network interface 116 may be used to connect electronic devices or computing devices 102-1...102-N to electrical systems at a control level. Further, the network interface 116 provide a multitude of solutions tailored for virtual network deployment and management, which efficiently optimize the distribution and management of virtual workloads, and provide maximum scalability and reduced bottleneck impediments to the system 100. Further, the network interface 116 may be easily integrated into existing hardware and architecture and may be configured for the deployment of virtual machine device queues. Further, the network interface 116 may be ideally suited for the consolidation of virtual network traffic in the system 100, without departing from the scope of the disclosure.

Further, the processing system 104 comprises the processor 118, which performs the operations run by the software module 110. In one embodiment, the processor 118 may be a digital signal controller (DSC) for processing the signals received during the method of adjusting the credit offer. The DSC may be a hybrid of microcontrollers and digital signal processors (DSPs). In another embodiment, the processor 118 may be a microcontroller to process the control signals received during the adjustment of the credit offer. The processor 118 may be manufactured by different manufacturers such as Microchip, Freescale, and Texas Instruments.

FIG. 2 illustrates the computing device 102, according to some examples. The computing device 102 may comprise an input and output (I/O) interface 202, a network interface 204, memory 206, a display interface 208, and at least one processor 210. It can be noted that the computer operable components of the system 100 for determining and implementing an adjustment may reside entirely on a single computing device, or may reside on a central server and run on any number of end-user devices via a communications network, without departing from the scope of the disclosure.

The I/O interface 202 may be used by the contractor, to provide project information or contractor credit offer. The I/O module 108 may comprise I/O devices, display devices, or group of devices may be augmented reality devices. The I/O devices may be controlled by an I/O controller. The I/O controller may control one or more I/O devices, such as, e.g., a keyboard and a pointing device, e.g., a mouse or optical pen. Furthermore, an I/O device may also allow storage and/or an installation medium for the computing device 102. In still other embodiments, the computing device 102 may allow USB connections (not shown) to receive handheld USB storage devices. In further embodiments, a I/O device may be a bridge between a system bus and an external communication bus, e.g. a USB bus, a SCSI bus, a FireWire bus, an Ethernet bus, a Gigabit Ethernet bus, a Fiber Channel bus, or a Thunderbolt bus.

The network interface 204 may, for ease of interaction by the contractor with information resident in the system 100 and for facilitating communication of the computing device 102 with the network 106. The network interface 204 may be specific to a contractor, set of contractor, or type of contractor, or may be the same for all users or a selected subset of contractor. The system software may also provide a master network interface 204 set that allows a contractor to select or interact with the network interface 204 of one or more other applications, or that allows a contractor to simultaneously access a variety of information otherwise available through any portion of the system. Further, the network interface 204 may perform signal transmission and distribution functions within the computing device 102.

The memory 206 may be used to store data related to the contractor, data related to the credit history, and current credit of the borrower or the user. Further, the memory 206 may be configured to store a systematic collection of data used for electronic storage and manipulation of data. The memory 206 may include structured data containing details of the users including the lender or the contractor and all other documents related to their agreement. In an embodiment, the memory 206 may include name and address of the lender and contractor, agreement terms and condition between the lender and the contractor. There are no limitations to the number, type or connectivity of the memory 206 utilized by the computing device 102.

The display interface 208 may correspond to output devices including, but not limited to, video displays, graphical displays, speakers, headphones, inkjet printers, laser printers, and 3D printers. In another embodiment, the display interface 208 may correspond to an input/output device like a touch screen, capable of receiving inputs from the user. Further, the display interface 208 may be a user device graphical user interface (GUI) or guided user interface(s) that may either accept inputs from users or facilitates outputs to the users, or may perform both the actions. In one case, a user can interact with the interface(s) using one or more user-interactive objects and devices. The user-interactive objects and devices may comprise user input buttons, switches, knobs, levers, keys, trackballs, touchpads, cameras, microphones, motion sensors, heat sensors, inertial sensors, touch sensors, or a combination of the above. Further, the interface(s) may either be implemented as a Command Line Interface (CLI), a GUI, a voice interface, or a web-based user-interface. The display interface 208 may facilitate the user to input data related to credit offers and the project information. In one embodiment, the display interface 208 may send notifications in a user-friendly or interactive form to the user.

The at least one processor 210 may perform the operations run by the memory 206. In one embodiment, the at least one processor 210 may be a digital signal controller (DSC) for processing the signals received during the method of adjusting the credit offer. The DSC may be a hybrid of microcontrollers and digital signal processors (DSPs). In another embodiment, the at least one processor 210 may be a microcontroller to process the control signals received during the adjustment of the credit offer. The at least one processor 210 may be manufactured by different manufacturers such as Microchip, Freescale, and Texas Instruments.

The computing device 102 may include at least one processor 210, I/O interface 202, as well as all hardware and software typically found on computing devices for storing data and running programs, and for sending and receiving data over the network 106, if needed. In one embodiment, if a central processing server is used, it may be one server, a combination of scalable servers, providing functionality as a network mainframe server, a web server, a mail server and/or a central database server, all maintained and managed by an administrator or operator of the system 100. The computing devices 102 may also be connected directly or via a network 106 to remote databases, such as for additional storage backup, and to allow for the communication of files, email, software, and any other data formats between two or more computing devices, such as between a user mobile device, client systems, lender systems and financial institution platforms. Further, the system 100 may utilize multiple number and a variety of databases utilized by the system 100, without departing from the scope of the disclosure. The network 106 may be a wide area network and may be any suitable networked system, such as, for example, an open, wide area network (e.g., the Internet), an electronic network, an optical network, a wireless network, a physically secure network or virtual private network, and any combinations thereof. The network 106 may also include any intermediate nodes, such as gateways, routers, bridges, Internet service provider networks, public-switched telephone networks, proxy servers, firewalls, and the like, such that the communications network may be suitable for the transmission of information items and other data throughout the system 100.

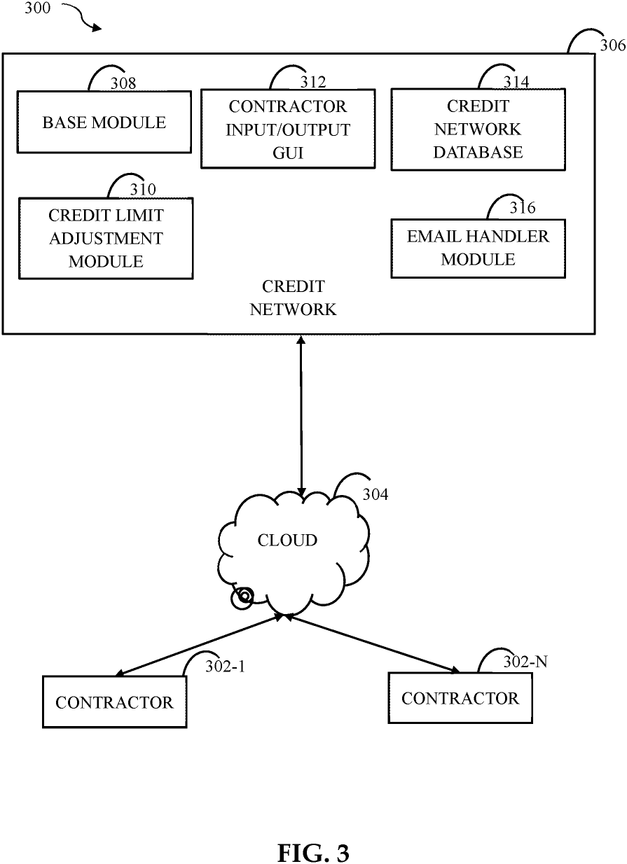

FIG. 3 illustrates a system 300 for adjusting a credit limit based on lien data of a contractor, according to some examples. The system 300 can be an example of the system 100, or vice versa. The system 300 may comprise one or more contractors 302-1...302-N, a cloud 304, and a credit network 306. The one or more contractors 302-1...302-N can be examples of the one or more computing devices 102-1... 102-N, or vice versa. The cloud 304 can be an example of the network 106, or vice versa. It can be noted that the one or more contractors 302-1...302-N may be in communication with the credit network 306, via the cloud 304, using one or more computing devices (e.g., the one or more computing devices 102-1... 102-N). It can be noted that the term contractor may be interchangeably used as a user or a borrower or a client. Further, the one or more contractors 302-1...302-N may be referred to as a contractor 302, hereinafter. Further, a contractor 302 may be a person, party, or an organisation which provides resources or services such as labour, material for completing a project, on a contract basis. Further, the contractor 302 may be catering to multiple clients at the same time and may have a financial history and business history based on his/her previous contracts.

In one embodiment, the contractor 302 may be using one or more computing devices, for connecting to the cloud 304. It can be noted that the one or more computing devices may be a computing device, desktop, laptop, smartphone, table, computer, smart speaker, smartphones, other wireless digital/cellular devices, or I/O devices. Hereinafter, the one or more computing devices may be referred to as a computing device. The computing device may comprise an input device and an output device. The input device may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. The output device may include video displays, graphical displays, speakers, headphones, inkjet printers, laser printers, and 3D printers. Devices may include a combination of multiple input or output devices, including, e.g., Sony PLAYSTATION, Microsoft XBOX, Microsoft KINECT, Nintendo Wii mote for the WII, Nintendo WII U GAMEPAD, Nintendo SWITCH, or Apple IPHONE. Some devices allow gesture recognition inputs through combining some of the inputs and outputs. Some devices allow for facial recognition which may be utilized as an input for different purposes including authentication and other commands, devices allow for voice recognition and inputs, including, e.g., Microsoft KINECT, SIRI for IPHONE by Apple, Google Now or Google Voice Search. Additional mobile devices have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), or force-based sensing technologies. Some multi-touch devices may allow two or more contact points with the surface, allowing advanced functionality including, e.g., pinch, spread, rotate, scroll, or other gestures.

Further, the cloud 304 may be implemented for connecting various devices/components in the system 300. The cloud 304 may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques, known in the art. The cloud 304 may allow ubiquitous access to shared pools of configurable resources and higher-level services that can be rapidly provisioned with minimal management effort, often over the internet and relies on sharing of resources to achieve coherence and economies of scale, like a public utility, while third-party clouds enable organizations to focus on their core businesses instead of expending resources on computer infrastructure and maintenance. The cloud 304 may also use standard architecture and protocols as understood by those skilled in the art, such as, for example, a packet switched network for transporting information and packets in accordance with a standard transmission control protocol/Internet protocol (“TCP/IP”). Additionally, the system 300 may utilize any conventional operating platform or combination of platforms (Windows, Mac OS, Unix, Linux, Android, etc.) and may utilize any conventional networking and communications software as would be understood by those skilled in the art. Additionally, the cloud 304 may be communicatively coupled to the one or more computing devices and the credit network 306, to facilitate the system 300 for adjusting the credit limit based on lien data of the contractor 302.

Further, the cloud 304 may facilitate sharing data of one or more contractors 302-1...302-N. Thus, to protect data of the contractor 302, such as sensitive user financial and personal identification data, government data related to the construction or site plans, other confidential data, and to comply with state and federal laws pertaining to protection of financial and personal identification data, an encryption standard may be used to protect files from unauthorized interception over the network. Any encryption standard or authentication method may be used at any point in the system of the disclosed systems and methods. For example, encryption may be accomplished by encrypting an output file by using a Secure Socket Layer (SSL) with dual key encryption. Additionally, the system may limit data manipulation, or information access. For example, a system administrator may allow for administration of the system at one or more levels, such as at an individual reviewer, a review team manager, a quality control review manager, or a system manager. Further, the system administrator may also implement access or use restrictions for users at any level. Such restrictions may include, for example, the assignment of user names and passwords required for use of the system run a check for or to implement an adjustment, backend administrative access, associated mobile device apps, or the selection of one or more data types that the subservient user is allowed to view or manipulate.

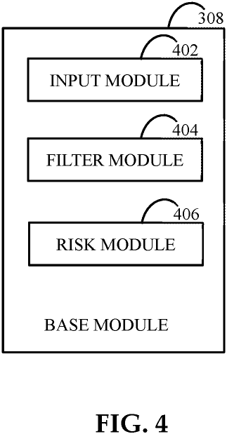

In one embodiment, the credit network 306 may be used to implement the methods described herein that provide adjustments to a financial instrument to adjust the credit limit. Further, the credit network 306 may comprise a base module 308, a credit limit adjustment module 310, a contractor input/output (I/O) graphic user interface (GUI) module 312, a credit network database 314, and an email handler module 316. The base module 308 may provide function of adjusting the credit limit based on lien data of the contractor 302. The base module 308 may also perform filtering of the contractor data from the credit network database 314. Further, the base module 308 may be responsible for determining the risk associated with the lien provided by the contractor 302, in light of the credit offer. Further, the base module 308 may facilitate sending mails to the contractor 302, with information related to the lien data associated with the contractor 302. It can be noted that the base module 308 may be explained in FIG. 4.

FIG. 4 illustrates a block diagram of the base module 308 for practicing embodiments of the method for adjusting the credit limit based on lien data of the contractor 302. The base module 308 may comprise an input module 402, a filter module 404, and a risk module 406. In one embodiment, the input module 402 may facilitate receiving information from the one or more contractors 102-1... 102-N. It can be noted that the information received from the one or more contractors 102-1... 102-N may include name of the contractor 302, contractor identification number (CIN), credit score, years in business, annual revenue, trade of contract, lien data, credit offer, payment performance. For example, the input module 402 receives the information of the contractor AB Flooring from the credit network database 314 as CIN – 717, credit score- 740, years in business -5 years, annual revenue- $3 million, and types of project- building construction, payment performance- credit offer L1 with a total amount of $4 million and failure to repay an earlier credit of $4 million to Lender 1 on time, credit offer of $300,000, and lien data for 73 Kings Street, including existing liens on the property from other contractors.. Further, the information received from the one or more contractors 102-1... 102-N may be stored in the credit network database 314.

Further, the filter module 404 may facilitate filtering information from the credit network database 314, based on one or more predefined filtering parameters. In one embodiment, the one or more predefined filtering parameters may be a particular contractor 302. For example, the filter module 404 filters information related to AB Flooring. In another embodiment, the one or more predefined filtering parameters may be contractors where there is related lien activity above a particular limit. For example, for having a single lien value or data available. Further, the risk module 406 may facilitate calculating a risk at the time when a credit offer is made and the risk may further determine parameter, not limited to, the credit offer interest rate, payment schedules, and penalties. For example, for AB Flooring with an initial credit offer applied for $300,000 and the credit offer of $300,000 and lien data for 73 Kings Street indicating existing liens on the property from other contractors, the risk module 406 calculates that the associated risk is high. It can be noted that more the lien, lesser would be the risk for the lender for providing the credit offer, or visa-versa.

Further, the credit limit adjustment module 310 may be responsible for adjusting the credit limit by generating a credit adjustment multiple based on the lien data of the contractor 302. It can be noted that the lien data of the contractor may be initially provided by the contractor 302 or identified independently. Further, the contractor I/O GUI module 312 may be a user device graphical user interface (GUI) or guided user interface(s) that may either accept inputs from users or facilitate outputs to the users, or may perform both the actions of input and output. In one case, a user can interact with the interface(s) using one or more user-interactive objects and devices. The user-interactive objects and devices may comprise user input buttons, switches, knobs, levers, keys, trackballs, touchpads, cameras, microphones, motion sensors, heat sensors, inertial sensors, touch sensors, or a combination of the above. Further, the interface(s) may either be implemented as a Command Line Interface (CLI), a GUI, a voice interface, or a web-based user-interface.

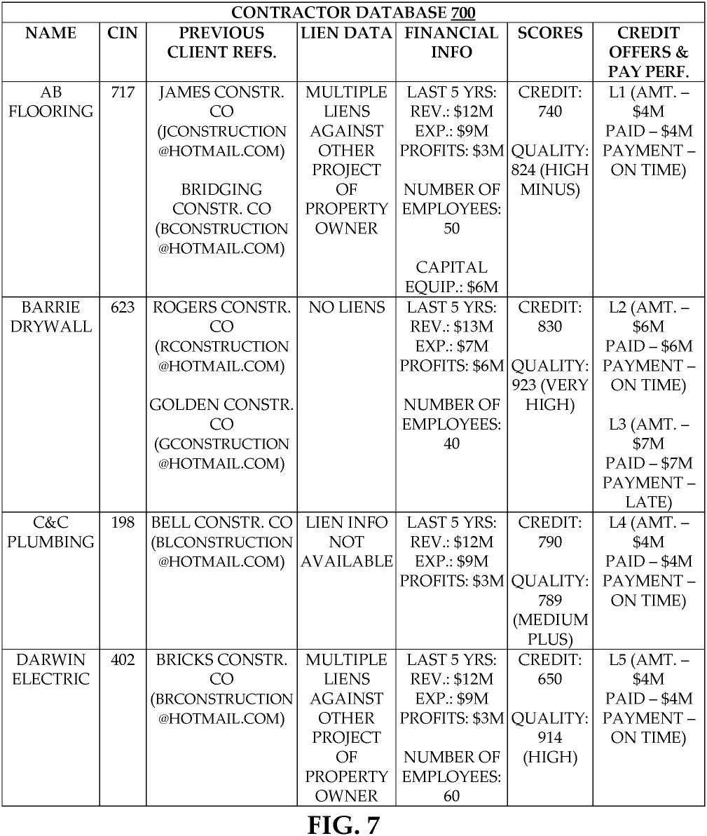

The credit network database 314 may be used to store data related to the one or more contractors 102-1... 102-N. The credit network database 314 may include structured data of all the contractors and sub-contractors in terms of their profiles, their contract for credit for materials, lien data in the contracts of when liens can be levied. In one embodiment, the data may include at least but not limited to credit score, years in business, annual revenue, type of project, payment performance, average project score, criminal history, civil judgments, outstanding debts, and lien history of the one or more contractors 102-1... 102-N. Further, the credit network database 314 may be configured to store a systematic collection of data used for electronic storage and manipulation of data. In one embodiment, the credit network database 314 may be of various types such as but not limited to centralized database, cloud database, and network database. It can be noted that the information stored in the credit network database 314 may reflect a robust picture of the contractor’s business and financial soundness. There are no limitations to the number, type or connectivity of the credit network database 314 utilized by the system 300. It can be noted that an exemplary credit network database 314 may be shown in FIG. 7.

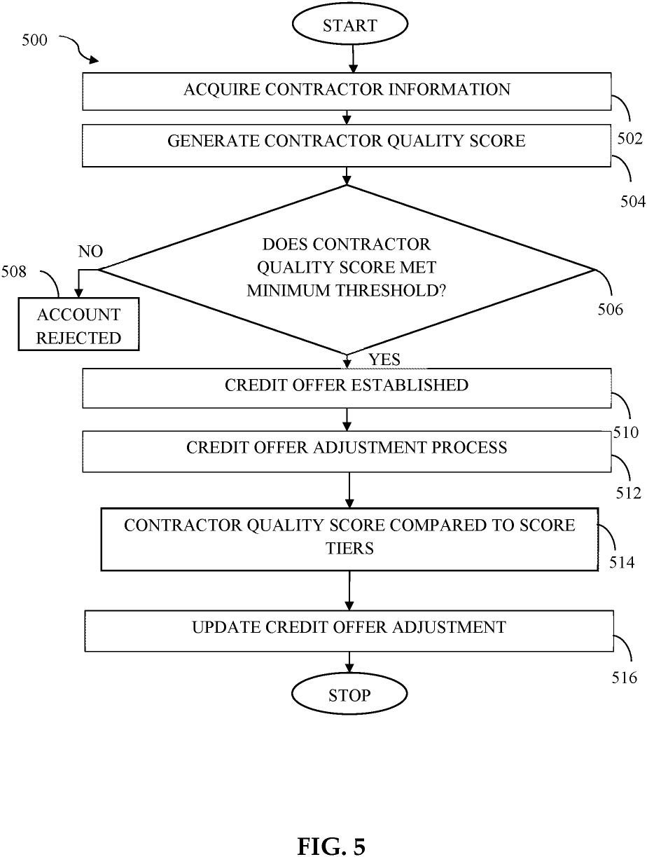

FIG. 5 illustrates a flow diagram 500 showing a method for using a contractor quality score to adjust a credit offer, according to some examples. It should also be noted that in some alternative implementations, the functions noted in the blocks may occur out of the order noted in the drawings. For example, two blocks shown in succession in FIG. 5 may be executed substantially concurrently or the blocks may sometimes be executed in the reverse order, depending upon the functionality involved. In one embodiment, the method may be a computer implemented method. In addition, the process descriptions or blocks in flow diagrams should be understood as representing decisions made by a hardware structure such as a state machine. The flow diagram 500 starts at operation 502 and proceeds to operation 516.

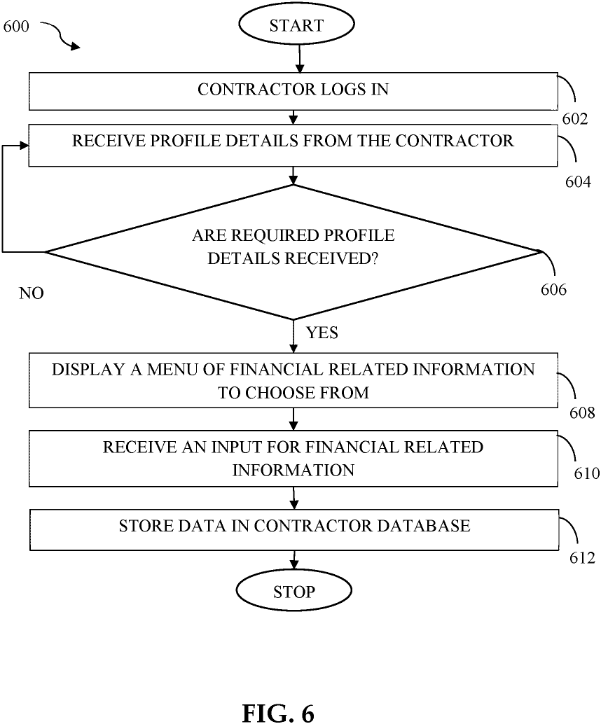

At first, a contractor input information may be acquired by the system 100, at operation 502. In one embodiment, the contractor may apply for the credit by inputting a predefined set of information. In one embodiment, the contractor input information may be received using the computing device 102. Further, the predefined set of information may include, but is not limited to, name of contractor, contractor identification (ID) number (CIN), credit score, years in business, annual revenue, trade of contractor, payment performance of the contractor, average project score of the contractor, criminal history, civil judgements, references of previous clients, outstanding debts, lien history, financial related information, and credit offers completed. For example, for contractor AB Flooring, with CIN – 917, references to previous clients - James construction company (jconstruction@hotmail.com) and Bridging construction company (bconstruction@hotmail.com), financial related information – profit over last five years $3 million, expenses over last five years $9 million, and number of employees 50, and credit offers completed - L1 of amount $4 million with payment of full amount on-time, asking for an account credit offer of $90,000. In one embodiment, the client information includes client contact information and contract information of the client. In another embodiment, the contract information of the client includes size of job engagement with the client. It can be noted that the process of acquiring contractor information may be explained in conjunction with FIG. 6.

FIG. 6 illustrates a flow diagram 600 showing a method for acquiring contractor information, according to some examples. It should also be noted that in some alternative implementations, the functions noted in the blocks may occur out of the order noted in the drawings. For example, two blocks shown in succession in FIG. 6 may be executed substantially concurrently or the blocks may sometimes be executed in the reverse order, depending upon the functionality involved. In addition, the process descriptions or blocks in flow diagrams should be understood as representing decisions made by a hardware structure such as a state machine. The flow diagram 600 starts at operation 602 and proceeds to operation 610.

At first, the contractor may log-in to the system 100, at operation 602. In one embodiment, the contractor may use the computing device 102 to log-in to the system 100, as discussed earlier. For example, a contractor - AB Flooring logs-in to the system 100. Once the contractor is successfully logged-in, the system 100 may receive profile details from the contractor, at operation 604. In one embodiment, the profile details may include, but are not limited to, name, address, CIN, website, and references of previous clients, such as contact information of previous clients. For example, the system 100 receives profile details of contractor AB Flooring, including name – AB Flooring, address – 51 Kings street, Chicago, and CIN – 917, and previous clients as James construction company (jconstruction@hotmail.com) and Bridging construction company (bconstruction@hotmail.com). In one embodiment, the method for utilizing information related to a contractor to adjust a credit offer comprises creating a contractor’s profile including at least one of contractor’s name, address, website, client information, and financial related information.

Further, the system 100 may determine whether required profile details are received, at operation 606. It can be noted that required profile details may include at least two among the profile details, including but not limited to, name, address, CIN, website, and references of previous clients, such as contact information of previous clients. In one case, if the system 100 determines that the required profile details are not received, then the system 100 may move to operation 604 to again receive the profile details from the contractor. For example, contractor AB Flooring only enters his name, then the system 100 may again prompt the contractor to provide additional profile details such as address etc., via the I/O interface 202.

In another case, if the system 100 determines that the required profile details are received, then the system 100 may move to operation 608, to display a menu of financial related information to choose from. In one embodiment, the menu of financial related information may be displayed on the display interface 208 of the computing device 102. Further, the menu of financial information may include, but is not limited to, contractor’s last five year revenues, last five year expenses, last five year profits, last five year paid credit offers and payments history, current open credit offers, list of capital equipment (trucks, tools, etc.), list of number of employees, list of all current subcontractors, list of current clients, contact information, and contract – size of current job engagement.

Further, the system 100 may receive an input for financial related information from the contractor, at operation 610. For example, the system 100 receives financial related information from contractor AB Flooring as, profits of last 5 years - $3 million, expenses of last 5 years - $9 million, number of employees - 50, revenue is growing on average of $3 million, and capital equipment is worth $6 million. Further, the system 100 may store the received financial related information in the contractor database 114, at operation 612. It can be noted that an exemplary contractor database 114 may be shown in FIG. 7.

FIG. 7 illustrates an exemplary contractor database 700. The exemplary contractor database 700 is an example of the contractor database 114 and/or the credit network database 314. For example, as shown in FIG. 7, the contractor database 114 comprises details related to contractor AB Flooring, including name – AB Flooring, CIN – 717, and previous clients as James construction company (jconstruction@hotmail.com) and Bridging construction company (bconstruction@hotmail.com), lien data for corresponding property 73 Kings Street including multiple liens against other project(s) of property owner, profits of last 5 years – $3 million, expenses of last 5 years - $9 million, number of employees – 50, and capital equipment is worth $6 million, credit score- 740, quality score – 824 (high minus), years in business -5, and credit offers completed – L1 with a total amount of $4 million and fully paid amount of $4 million on time. Further, the contractor database 114 comprises details related to contractor Barrie Drywall, including name – Barrie Drywall, CIN – 623, and previous clients as Rogers construction company (rconstruction@hotmail.com) and Golden construction company (gconstruction@hotmail.com), lien data indicating no liens, profits of last 5 years – $6 million, expenses of last 5 years - $7 million, and number of employees – 40, credit score- 830, quality score – 830 (very high), years in business -7, and credit offers completed – L2 with a total amount of $4 million and fully paid amount of $4 million on time and L3 with a total amount of $7 million and fully paid amount of $7 million, paid late. Further, the contractor database 114 comprises details related to contractor C&C Plumbing, including name –C&C Plumbing, CIN – 198, and previous clients as Bell construction company (blconstruction@hotmail.com), lien data not available (e.g., could not be found), profits of last 5 years – $3 million, expenses of last 5 years - $9 million, credit score- 790, quality score – 789 (medium plus), years in business -6, and credit offers completed - L4 with a total amount of $4 million and fully paid amount of $4 million on time. Further, the contractor database 114 comprises details related to contractor Darwin Electric, including name –Darwin Electric, CIN –402, and previous clients as Bricks construction company (brconstruction@hotmail.com), lien data for corresponding property 74 Kings Street including multiple liens against other project(s) of property owner, profits of last 5 years – $3 million, expenses of last 5 years - $9 million, number of employees – 60, credit score- 650, quality score – 914 (high), years in business -4, and credit offers completed – L5 with a total amount of $4 million and fully paid amount of $4 million on time.

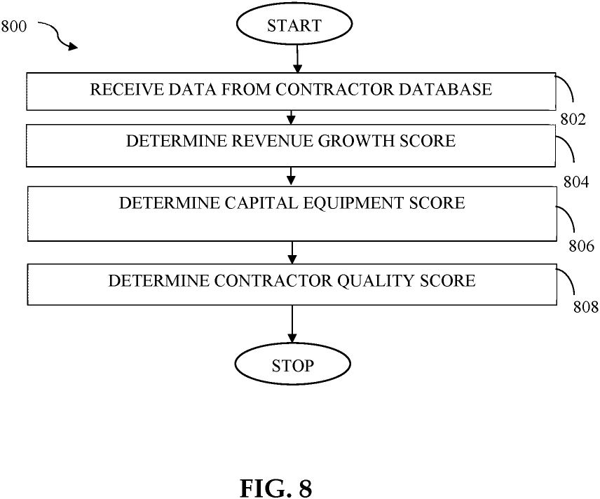

Further, it should be obvious to those skilled in the art that the contractor database 114 may be built over time, to have a wide variety of data to correlated the scores to payment results. Further, based on the acquired contractor information, the system 100 may generate a contractor quality score, at operation 504. For example, for contractor AB Flooring, the contractor quality score is determined to be 824. It can be noted that the process of generation of quality score may be explained in conjunction with FIG. 8. FIG. 8 illustrates a flow diagram 800 showing a method for generating the contractor quality score, according to some examples. It should also be noted that in some alternative implementations, the functions noted in the blocks may occur out of the order noted in the drawings. For example, two blocks shown in succession in FIG. 8 may be executed substantially concurrently or the blocks may sometimes be executed in the reverse order, depending upon the functionality involved. In addition, the process descriptions or blocks in flow diagrams should be understood as representing decisions made by a hardware structure such as a state machine. The flow diagram 800 starts at operation 802 and proceeds to operation 808.

At first, the system 100 may receive data from the contractor database 114, at operation 802. For example, for AB Flooring, the system receives data from the contractor database 114 as AB Flooring, CIN – 917, and previous clients as James construction company (jconstruction@hotmail.com) and Bridging construction company (bconstruction@hotmail.com), profits of last 5 years – $3 million, expenses of last 5 years — $9 million, number of employees – 50, and capital equipment is worth $6 million, and credit offers completed — L1 with a total amount of $4 million and fully paid amount of $4 million on time.

Further, based on the received data from the contractor database 114, the system 100 may determine a revenue growth score, at operation 804. In one embodiment, the system 100 may determine the revenue growth score as - revenue is growing on average over 5 years is > or equal to 10%, then revenue growth score = 10. In another embodiment, if revenue is growing on average over 5 years is <10 and > 7%, then revenue growth score = 7. In another embodiment, if revenue is growing on average over 5 years is <7 and > 5%, then revenue growth score = 5. In another embodiment, if revenue is growing on average over 5 years is <5 and > 0%, then revenue growth score = 3. In yet another embodiment, if revenue is growing on average over 5 years is <0%, then revenue growth score = 0. For example, for AB Flooring, the revenue is growing on average of $3 million, the revenue growth score is 3.

Further, based on the received data from the contractor database 114, the system 100 may determine a capital equipment score, at operation 806. In one embodiment, the system 100 may determine the capital equipment score as - adding all capital equipment together = total capital equipment. In another embodiment, if the capital equipment is > 5 million, then capital equipment score = 10. In another embodiment, if the capital equipment is > 1 million and <5 million, then capital equipment score = 5. In another embodiment, if the capital equipment is > 5 million, then capital equipment score = 0. For example, for AB Flooring, the capital equipment of worth $6 million, the capital equipment score is 10.

Further, it can be noted that the disclosure may not be limited to revenue score or the capital equipment score, rather any sub-score can be used to transform the contractor information. In one embodiment, other sub-scores which may be determined from the contractor information may include, but are not limited to, credit offer payment sub-score, previous client feedback sub-score, location sub-score, market performance sub-score. Further, the sub-scores may be used to determine a contractor quality score, by using the sub-scores in an equal or in a weighted manner.

In one embodiment, based on the determined revenue growth score and the capital equipment score, the system 100 may determine the contractor quality score, at operation 808. In one embodiment, if the revenue growth score is 10 through 7 and capital equipment score is 10, then contractor quality score – very high. In another embodiment, if the revenue growth score is 5 and capital equipment score is 10, then contractor quality score -high. In another embodiment, if the revenue growth score is 3 and capital equipment score is 10, then contractor quality score –high minus. In another embodiment, if the revenue growth score is 0 and capital equipment score is 10, then contractor quality score – medium.

In one embodiment, if the revenue growth score is 10 through 7 and capital equipment score is 5, then contractor quality score –high plus. In another embodiment, if the revenue growth score is 5 and capital equipment score is 5, then contractor quality score –high. In another embodiment, if the revenue growth score is 3 and capital equipment score is 10, then contractor quality score –medium minus. In another embodiment, if the revenue growth score is 0 and capital equipment score is 5, then contractor quality score – medium. In one embodiment, if the revenue growth score is 10 through 7 and capital equipment score is 0, then contractor quality score – very high. In another embodiment, if the revenue growth score is 5 and capital equipment score is 10, then contractor quality score –high. In another embodiment, if the revenue growth score is 3 and capital equipment score is 10, then contractor quality score –high minus. In another embodiment, if the revenue growth score is 0 and capital equipment score is 10, then contractor quality score –medium. In one embodiment, if the revenue growth score is 10 through 7 and capital equipment score is 0, then contractor quality score – medium plus. In another embodiment, if the revenue growth score is 5 and capital equipment score is 0, then contractor quality score –medium. In another embodiment, if the revenue growth score is 3 and capital equipment score is 0, then contractor quality score –poor plus. In another embodiment, if the revenue growth score is 0 and capital equipment score is 0, then contractor quality score – poor. For example, for AB FlooringAB Flooring, with a revenue sore of 3 and a capital equipment score of 10, the contractor quality score is high minus. Further, in this example, the contractor quality score for AB Flooring is determined to be 824, as shown in FIG. 7.

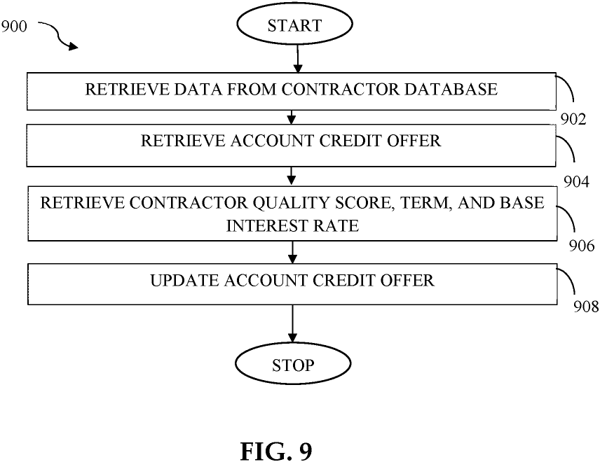

Further, the system 100 may determine whether the generated contractor quality score is above a threshold value, at operation 506. In one embodiment, the threshold value may be predefined. It can be noted that the threshold value may be based on the market analysis among various lenders and contractors. For example, for a lender, the threshold value of contractor quality score is 900. In one case, if the system 100 determines that the contractor quality score is not above the threshold value, the system 100 may reject the account of the contractor, at operation 508. For example, if AB Flooring’s contractor quality score is 850 and is below the contractor quality score of 900 for lender, then AB Flooring’s account is rejected. In another case, if the system 100 determines that the contractor quality score is above the threshold value, the system 100 may establish a credit offer, at operation 510. In one embodiment, if the account credit offer is above the minimum threshold, then the account is approved. For example, for AB Flooring, with a quality score of 824, the minimum threshold requirement of contractor quality score of 900 is met, the credit offer is established at the asking credit for $90,000. Further, the system 100 may initiate the credit offer adjustment process, at operation 512. It can be noted that the process for credit offer adjustment is explained in conjunction with FIG. 9. FIG. 9 illustrates a flow diagram 900 showing a method of updating the credit offer, according to some examples. It should also be noted that in some alternative implementations, the functions noted in the blocks may occur out of the order noted in the drawings. For example, two blocks shown in succession in FIG. 9 may be executed substantially concurrently or the blocks may sometimes be executed in the reverse order, depending upon the functionality involved. In addition, the process descriptions or blocks in flow diagrams should be understood as representing decisions made by a hardware structure such as a state machine. The flow diagram 900 starts at operation 902 and proceeds to operation 908.

At first, the system 100 may retrieve data from the contractor database, at operation 902. For example, for contractor AB Flooring, the system 100 retrieves data from the contractor database 114 as, CIN – 917, and previous clients as James construction company (jconstruction@hotmail.com) and Bridging construction company (bconstruction@hotmail.com), profits of last 5 years – $3 million, expenses of last 5 years - $9 million, and number of employees – 50, and credit offers completed – L1 with a total amount of $4 million and fully paid amount of $4 million on time.

Further, the system 100 may receive credit offer, at operation 904. In one embodiment, the system 100 may receive the credit offer from the contractor, via the computing device 102. For example, the system 100 receives the credit offer of $90,000 for AB Flooring. Further, the system may receive contractor quality score, term, and a base interest rate, at operation 906. For example, for AB Flooring, the quality score is 824 (very high) and the term for the credit offer is 2 years with a base interest rate of 3%.

Based on the contractor quality score, term and the base interest rate, the system 100 may update the credit offer, at operation 908. It can be noted that a good contractor quality score may result in a good credit offer or a good interest rate. For example, for very high contractor quality score of AB Flooring, i.e. 824, the updated credit offer is 1,00,000 at a reduced base interest rate of 2.8%. Further, the system 100 may compare the contractor quality score to score tiers, at operation 514. For example, the system 100 compares the contractor quality score of AB Flooring, to tiers, like Darwin Electric, who has a similar financial related information but different previous client references, thus leading to higher quality score. Finally, the system 100 may update the credit offer adjustment, at operation 516. In one embodiment, the system may update the credit offer adjustment based on the tiers. For example, when comparing to Darwin Electric with an asking credit for 1,50,000 and contractor quality score of 914, the system 100 updates the credit offer for AB Flooring, to 1,10,000, for overall score of 824.

Further, the system 100 may determine if the project credit offer is more than the account credit offer, at operation 606. In one case, if the project credit offer is not more than the account credit offer, then the system 100 may set the account credit offer to the project credit offer, at operation 608. For example, for a project credit offer of $70,00,000, then count credit offer of $90,00,000 is also set to $70,00,000. In another case, if the project credit offer is more than the account credit offer, then the system 100 may apply the credit offer adjustment, at operation 610. For example, for contractor AB Flooring, with tax id – 979, DOB – Apr. 5, 1989, credit score – 826, a residential property at 31 King Street, Chicago, with account credit offer received is $90,00,000 and the project account offer of $100,00,000, the account credit offer is set to $100,00,000, with an adjustment multiple of $10,00,000. In one embodiment, the adjustment multiple may be based on a percentage of the value of new projects that come in. For example, if a summation of the project credit offer is greater than the account credit offer, then the contractor may receive an adjustment. In another embodiment, the system 100 may offer adjusted credit based on the ability of the client to attract more valuable projects. Further, a part of the property research and attributes evaluated may be used as a criterion for credit adjustment eligibility.

The system and method for utilizing information related to a contractor to adjust a credit offer may also include standard reporting mechanisms, such as generating a printable receipt of the transaction, or an electronic results report that can be transmitted to any communicatively connected computing device, such as a generated email message or file attachment. Likewise, particular results of the system transaction can trigger an alert signal, such as the generation of an alert email, text or phone call, to alert a user, financial institution or person associated with the user or financial institution. Further embodiments of such mechanisms are described below and according to standards of such systems understood by those skilled in the art.

The subject disclosure describes a method for utilizing information related to a contractor to adjust a credit offer. It can be noted that the system 100 and method according to one embodiment may execute the method and algorithms for implementing an adjustment to a financial instrument which can include one or more local or remote executable software platforms, mobile device platforms, or a hosted Internet or network program or portal. In one embodiment, only portions of the system are computer operated, and in other embodiments, the entire system is computer operated. In one embodiment, client users may run an application on their mobile devices so that the system 100 can be easily accessed in real time at a construction site. The system and method for utilizing information related to a contractor to adjust a credit offer is fully integral for use with any additional platform and data output that may be used for communicating with other platforms, such as for example financial institution platforms, user information platforms, cyber security platforms and payment collection platforms.

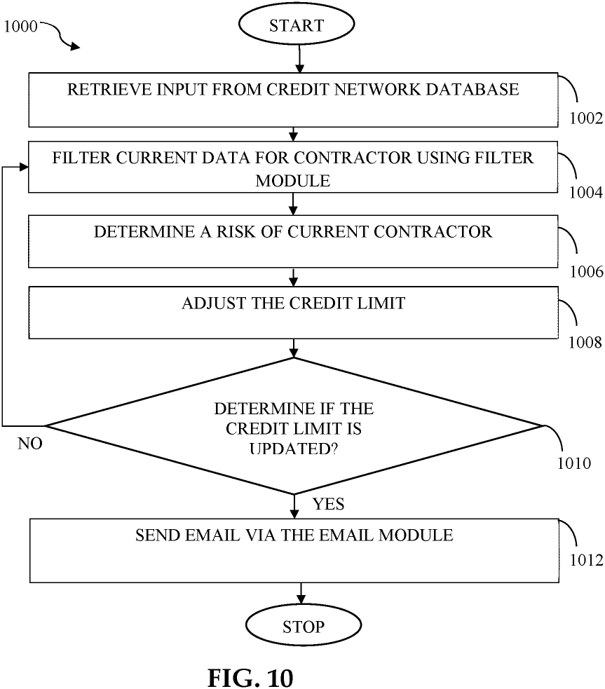

FIG. 10 illustrates a flow diagram 1000 showing a method for adjusting a credit limit based on lien data, according to some examples. It should also be noted that in some alternative implementations, the functions noted in the blocks may occur out of the order noted in the drawings. For example, two blocks shown in succession in FIG. 10 may be executed substantially concurrently or the blocks may sometimes be executed in the reverse order, depending upon the functionality involved. In addition, the process descriptions or blocks in flow diagrams should be understood as representing decisions made by a hardware structure such as a state machine. The flow diagram 1000 starts at operation 1002 and proceeds to operation 1012.

At first, a contractor input information may be retrieved by the system 300 from the credit network database 314, using the input module 402, at operation 1002. It can be noted that the input information may be provided that the contractor 302. In one embodiment, the contractor 302 may apply for credit by inputting a predefined set of information. In one embodiment, the contractor input information may be received using the computing device. Further, the predefined set of information may include, but is not limited to, name of the contractor 302, contractor identification number (CIN), credit score, years in business, annual revenue, trade of contract, lien data, credit offer, payment performance. For example, for contractor AB Flooring the contractor input information retrieved, by the system 300, from the credit network database 314 is CIN – 717, credit score- 740, years in business -5 years, annual revenue- $3 million, and types of project- building construction, payment performance- credit offer L1 with a total amount of $4 million and failure to pay $4 million on time and lien data for 73 Kings Street. 1. In one embodiment, the system 300 may establish a credit offer, based on the contractor input information. For example, a credit offer of $300,000 is established for AB Flooring. Further, the contractor input information may correspond to lien information and may include attributes like lien type, lien use, schedule of improvements and eligibility for adjustments.

Based on the input information, the system 300 may filter the retrieved data for the contractor 302, using the filter module 404, at operation 1004. It can be noted that the filter module 404 may facilitate filtering information from the credit network database 314, based on one or more predefined filtering parameters. In one embodiment, the one or more predefined filtering parameters may be a particular contractor 302. In another embodiment, when the system 300 performs the method for a first time, then the flow diagram 1000 starts with a first contractor of the credit network database 314. For example, the filter module 404 filters information related to AB Flooring i.e. the current or first contractor in the credit network database 314. In another embodiment, the one or more predefined filtering parameters may be contractors which have lien above a particular limit. In one embodiment, the threshold for lien value is a single lien available.

Further, the system 300 may determine a risk associated with the contractor 302, at operation 1006. In one embodiment, the risk associated with a particular contractor 302 may be determined based on the credit offer and the lien information. For example, AB Flooring with an initial credit offer applied for $300,000, and the credit offer of $300,000 and lien data for 73 Kings Street,., the associated risk is high. It can be noted that the risk module 406 may facilitate calculating a risk at a time when a credit offer is made and the risk may further determine parameter, not limited to, the credit offer interest rate, payment schedules, and penalties. Further, the presence of lien related to the contractor provides a negative factor that would lower the credit offer of the contractor. It can be noted that more the lien value, higher would be the risk for the lender for providing the credit offer, or visa-versa.

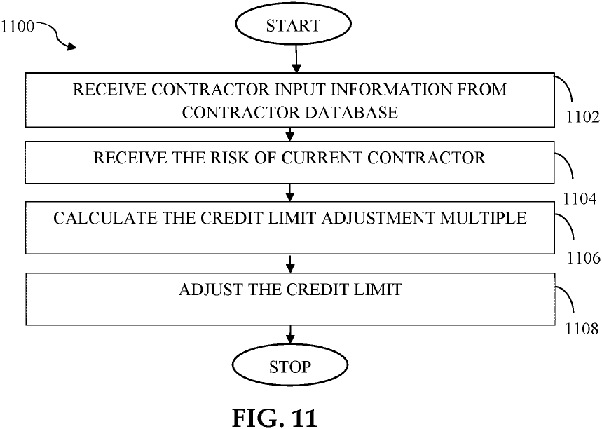

Further, the system 300 may adjust the credit limit of the contractor 302 based on the determined risk, at operation 1008. It can be noted that operation of adjusting the credit limit of the contractor 302 may be explained in FIG. 11. FIG. 11 illustrates a flow diagram 1100 showing a method for the operation of adjusting the credit limit, according to some examples. It should also be noted that in some alternative implementations, the functions noted in the blocks may occur out of the order noted in the drawings. For example, two blocks shown in succession in FIG. 11 may be executed substantially concurrently or the blocks may sometimes be executed in the reverse order, depending upon the functionality involved. In addition, the process descriptions or blocks in flow diagrams should be understood as representing decisions made by a hardware structure such as a state machine. The flow diagram 1100 starts at operation 1102 and proceeds to operation 1108.

At first, the contractor input information may be received from the credit network database 314, at operation 1102. For example, for contractor AB Flooring, the contractor input information retrieved, by the system 300, from the credit network database 314 is CIN – 717, credit score- 740, years in business -5 years, annual revenue- $3 million, and types of project- building construction, payment performance- credit offer L1 with a total amount of $4 million and failure to pay $4 million on time, credit offer of $300,000, and lien data for 73 Kings Street.

Further, the system 300 may receive the risk for the current contractor 302, at operation 1104. For example, the system 300 receives that for AB Flooring with an initial credit offer applied for $300,000 and the credit offer of $300,000 and lien data for 73 Kings Street, the associated risk is high. Further, based on the received contractor input information and the risk of the current contractor 302, the system 300 may calculate the credit limit adjustment multiple, at operation 1106. For example, for AB Flooring, the system determines that for initial credit offer applied for $300,000 and the credit offer of $300,000, and lien data for 73 Kings Street, with the associated high, an adjustment multiple of -$10,000.

Further, the system 300 may adjust the credit limit, based on the credit offer and the calculated credit limit adjustment multiple, at operation 1108. It can be noted that the system 300 may include the risks to provide a fraud-proof credit offer satisfaction to the lender with less risk of unknowingly providing credit offer to the contractor 302. For example, the system adjusts the credit limit as: credit offer applied and the adjustment multiple: $300,000, - $10,000, = $90,000. Further, the adjusted credit limit may be stored in the credit network database 314.

In one embodiment, the system 300 may adjust credit payment timeliness. It can be noted for adjusting credit payment timeliness, the system 300 may determine a payment dates factor. In one embodiment if all the payments are done on time, then the credit limit adjustment may be made along with an email offering more credit. In another embodiment, if one payment is late, then the credit limit adjustment may be made along with an email for friendly reminder. In yet another embodiment, if all the payments are late, then the credit limit adjustment may be made along with an email with notification for pending lien. In yet another embodiment, if all the payments are late, then the credit limit adjustment may be made along with an email for lien.

In another embodiment, the system 300 may adjust credit payment amounts. It can be noted for adjusting credit payment timeliness, the system 300 may determine a payment factor. In one embodiment if all the payments are done correctly, then the credit limit adjustment may be made along with an email offering more credit. In another embodiment, if one payment is paid less than required, then the credit limit adjustment may be made along with an email for friendly reminder. In yet another embodiment, if all the payments are underpaid, then the credit limit adjustment may be made along with an email with notification for pending lien. In yet another embodiment, if all the payments are not paid at all, then the credit limit adjustment may be made along with an email for lien.

In yet another embodiment, the system 300 may adjust credit payment data and time. It can be noted for adjusting credit payment timeliness, the system 300 may determine whether the contractor 302 as made any request for extension to payment. Further, the system 300 may determine whether the payments are off by a set amount. For example, for AB Flooring, with failure to pay on time, the system 300 sends an email for offering less credit of $10,000.

In one embodiment, the system 300 may determine if the credit limit is updated, at operation 1010. In one case, if the system 300 determines that the credit limit is not updated, then the system 300 may select a next contractor 302 and moves to operation 1004, to repeat the method for adjusting the credit limit. For example, for AB Flooring, if the credit limit is not updated, then the system repeats the process for Barrie Drywall. In another case, if the system 300 determines that the credit limit is updated, then the system 300 may send emails to the contractor 302, using the email handler module 316, at operation 1012. For example, for AB Flooring, the credit limit is updated to $90,000, then the system sends an email to the contractor 302 with the updated credit limit. In one embodiment, if a lien was detected the first time, the email handler module 316 may send a contractor email. In another embodiment, if a lien was detected the first time, the email handler module 316 may send a data about a lien. In yet another embodiment, if a lien was detected the first time, the email handler module 316 may be sent a code for an email from the base module 308. In yet another embodiment, if a lien was detected the first time, the email handler module 316 may be sent a credit adjustment.

In one exemplary embodiment, when a contractor project has detected a lien, the base module 308 may send the data as well as say send the code for the email from the base module 308. Further, the email handler module 316 may take the email and populates it with the contractor email, the data about the lien, and the credit risk has gone up so there will be a credit limit adjustment of “X” as well as stock information of in the email. In this way a lender being doesn’t have to aggregate information and create and email. The email handler module 316 may ping to look at emails that are returned and may automatically, through machine learning classify or categorize a return email, such as, contractor 302 agrees or contractor 302 would like to talk to the lender. It can be noted that the email handler module 316 may be in communication with the base module 308.

The system and method for utilizing a lien to implement an adjustment may also include standard reporting mechanisms, such as generating a printable receipt of the transaction, or an electronic results report that can be transmitted to any communicatively connected computing device, such as a generated email message or file attachment. Likewise, particular results of the system transaction can trigger an alert signal, such as the generation of an alert email, text or phone call, to alert a user, financial institution or person associated with the user or financial institution. Further embodiments of such mechanisms are described below and according to standards of such systems understood by those skilled in the art.

The subject disclosure describes a method for adjusting the credit limit based on lien data It can be noted that the system 300 and method according to one embodiment may execute the method and algorithms for implementing an adjustment to a financial instrument which can include one or more local or remote executable software platforms, mobile device platforms, or a hosted Internet or network program or portal. In one embodiment, only portions of the system are computer operated, and in other embodiments, the entire system is computer operated. In one embodiment, client users may run an application on their mobile devices so that the system 300 can be easily accessed in real time at a construction site. The system and method for utilizing a mechanic’s lien for implementing an adjustment is fully integral for use with any additional platform and data output that may be used for communicating with other platforms, such as for example financial institution platforms, user information platforms, cyber security platforms and payment collection platforms. Further, the method may be a continuous process as long as there is an outstanding balance in credit amount. Further, the credit may be frozen or limited, when a threshold number of liens come up.

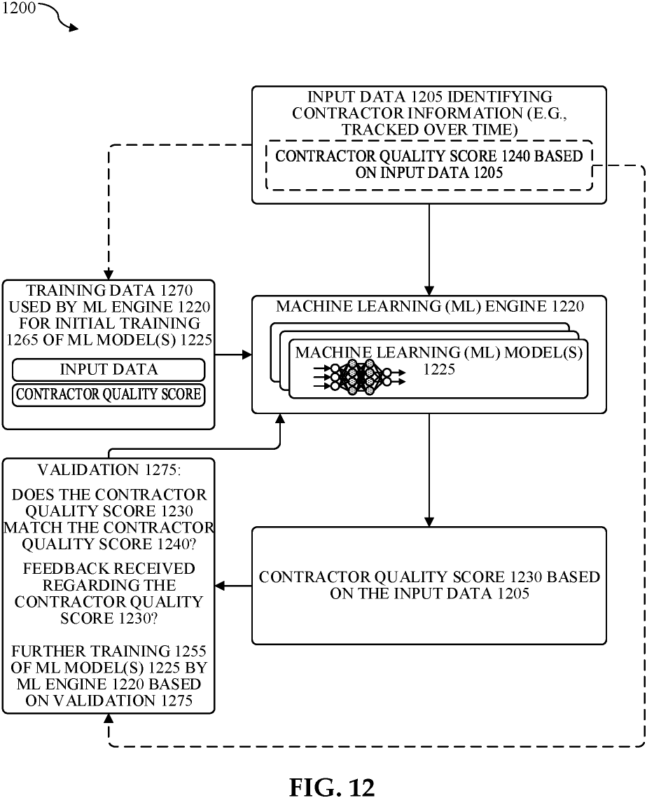

FIG. 12 is a block diagram 1200 illustrating use of one or more trained machine learning models 1225 of a machine learning engine 1220 to generate a contractor quality score 1230 for a contractor based on input data 1205 about the contractor. The ML engine 1220 and/or the ML model(s) 1225 can include one or more neural network (NNs), one or more convolutional neural networks (CNNs), one or more trained time delay neural networks (TDNNs), one or more deep networks, one or more autoencoders, one or more deep belief nets (DBNs), one or more recurrent neural networks (RNNs), one or more generative adversarial networks (GANs), one or more conditional generative adversarial networks (cGANs), one or more other types of neural networks, one or more trained support vector machines (SVMs), one or more trained random forests (RFs), one or more computer vision systems, one or more deep learning systems, one or more classifiers, one or more transformers, or combinations thereof. Within FIG. 12, a graphic representing the trained ML model(s) 1225 illustrates a set of circles connected to another. Each of the circles can represent a node, a neuron, a perceptron, a layer, a portion thereof, or a combination thereof. The circles are arranged in columns. The leftmost column of white circles represent an input layer. The rightmost column of white circles represent an output layer. Two columns of shaded circled between the leftmost column of white circles and the rightmost column of white circles each represent hidden layers. The ML engine 1220 and/or the ML model(s) 1225 can be part of any AI and/or ML modules and/or processes discussed herein.

Once trained via initial training 1265, the one or more ML models 1225 receive, as an input, input data 1205 that identifies information about a contractor (e.g., financial information, business information, revenue information, expense information, profit information, information about a property that the contractor worked on or works on or is scheduled to work on, status one or more projects that the contractor worked on or works on or is scheduled to work on, information about a general contractor that the contractor worked with or works with or is scheduled to work with, reviews or references from clients of the contractor, client information, lien information regarding lien(s) taken by the contractor, credit offer history information regarding credit offer(s) made to and/or accepted by the contractor, payment history of payments on credit by the contractor, credit score(s) for the contractor, quality information about quality of the contractor’s work and/or ability to make timely payment(s) on credit, risk information about risks in the contractor’s work and/or ability to make timely payment(s) on credit, any other information about a contractor discussed herein, or a combination thereof). In some examples, the input data 1205 identifies the information about the contractor (e.g., of any of the types listed above) as tracked over time (e.g., over a period of time), for instance as tracked using at least one database.

Identifying the quality score 1230 can correspond to at least the credit limit adjustment module 310, the risk module 406, and/or operations 504, 516, 804, 806, 808, 906, 908, 1006, 1008, 1104, 1108, 1310, or a combination thereof. It should be understood that the pre-determined contractor quality score 1240 can likewise include any of the types of contractor quality score information listed above with respect to the contractor quality score 1230.

Once the one or more ML models 1225 identify the contractor quality score 1230, the contractor quality score 1230 can be output to an output interface that can indicate the contractor quality score 1230 to a user (e.g., by displaying the contractor quality score 1230 using a display or playing audio indicative of the contractor quality score 1230 using a speaker or headphones) and/or to a recipient device that can modify or adjust an amount associated with the contractor, such as a credit offer for the contractor, an adjustment multiple for the credit offer, and the like.

Before using the one or more ML models 1225 to identify the contractor quality score 1230, the ML engine 1220 performs initial training 1265 of the one or more ML models 1225 using training data 1270. The training data 1270 can include examples of input data identifying contractor information (e.g., tracking contractor information over time) (e.g., as in the input data 1205) and/or examples of a pre-determined contractor quality score (e.g., as in the pre-determined contractor quality score 1240). In some examples, the pre-determined contractor quality score(s) in the training data 1270 are contractor quality score(s) that the one or more ML models 1225 previously identified based on the input data in the training data 1270. In the initial training 1265, the ML engine 1220 can form connections and/or weights based on the training data 1270, for instance between nodes of a neural network or another form of neural network. For instance, in the initial training 1265, the ML engine 1220 can be trained to output the pre-determined contractor quality score in the training data 1270 in response to receipt of the corresponding input data in the training data 1270.

During a validation 1275 of the initial training 1265 (and/or further training 1255), the input data 1205 (and/or the exemplary input data in the training data 1270) is input into the one or more ML models 1225 to identify the contractor quality score 1230 as described above. The ML engine 1220 performs validation 1275 at least in part by determining whether the identified contractor quality score 1230 matches the pre-determined contractor quality score 1240 (and/or the pre-determined contractor quality score in the training data 1270). If the contractor quality score 1230 matches the pre-determined contractor quality score 1240 during validation 1275, then the ML engine 1220 performs further training 1255 of the one or more ML models 1225 by updating the one or more ML models 1225 to reinforce weights and/or connections within the one or more ML models 1225 that contributed to the identification of the contractor quality score 1230, encouraging the one or more ML models 1225 to make similar contractor quality score determinations given similar inputs. If the contractor quality score 1230 does not match the pre-determined contractor quality score 1240 during validation 1275, then the ML engine 1220 performs further training 1255 of the one or more ML models 1225 by updating the one or more ML models 1225 to weaken, remove, and/or replace weights and/or connections within the one or more ML models that contributed to the identification of the contractor quality score 1230, discouraging the one or more ML models 1225 from making similar contractor quality score determinations given similar inputs.

Validation 1275 and further training 1255 of the one or more ML models 1225 can continue once the one or more ML models 1225 are in use based on feedback 1250 received regarding the contractor quality score 1230. In some examples, the feedback 1250 can be received from a user via a user interface, for instance via an input from the user interface that approves or declines use of the contractor quality score 1230 for adjusting the account credit offer. In some examples, the feedback 1250 can be received from another component or subsystem, for instance based on whether the component or subsystem successfully uses the contractor quality score 1230, whether use the contractor quality score 1230 causes any problems for the component or subsystem, whether use the contractor quality score 1230 are accurate, or a combination thereof. If the feedback 1250 is positive (e.g., expresses, indicates, and/or suggests approval of the contractor quality score 1230, success of the contractor quality score 1230, and/or accuracy the contractor quality score 1230), then the ML engine 1220 performs further training 1255 of the one or more ML models 1225 by updating the one or more ML models 1225 to reinforce weights and/or connections within the one or more ML models 1225 that contributed to the identification of the contractor quality score 1230, encouraging the one or more ML models 1225 to make similar contractor quality score determinations given similar inputs. If the feedback 1250 is negative (e.g., expresses, indicates, and/or suggests disapproval of the contractor quality score 1230, failure of the contractor quality score 1230, and/or inaccuracy of the contractor quality score 1230) then the ML engine 1220 performs further training 1255 of the one or more ML models 1225 by updating the one or more ML models 1225 to weaken, remove, and/or replace weights and/or connections within the one or more ML models that contributed to the identification of the contractor quality score 1230, discouraging the one or more ML models 1225 to make similar contractor quality score determinations given similar inputs.

In some examples, the one or more ML models 1225 generate an adjustment multiple (e.g., as in operations 514, 516, 908, 1008, 1106, 1108, and/or 1320) for the credit offer instead of or in addition to generating the contractor quality score 1230. In such examples, the input data 1205 can include the contractor quality score 1230.

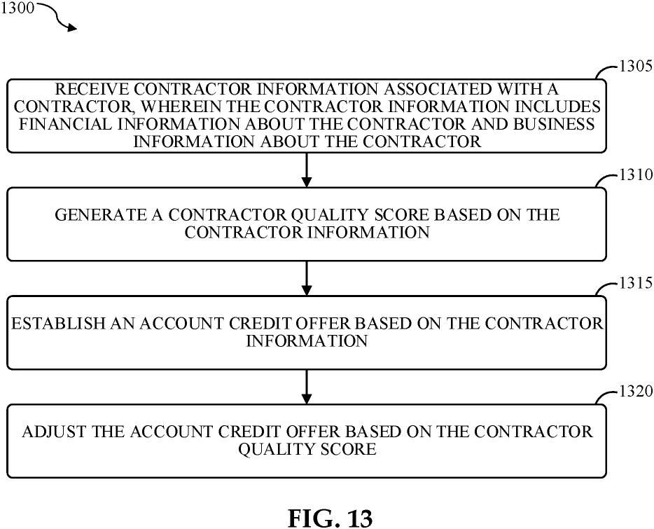

FIG. 13 is a flow diagram illustrating a process 1300 for contractor analysis performed using an analysis system. The analysis system that performs the process 1300 can include the system 100, the one or more computing devices 102-1...102-N, the processing system 104, the network 106, the system 300, the one or more contractors 302-1...302-N, the cloud 304, the credit network 306, the base module 308, any system(s) that perform any of the processes of any of FIGS. 5-6, the contractor database 700, any system(s) that perform any of the processes of any of FIGS. 8-11, the ML engine 1220, the trained ML model(s) 1225, an apparatus, a non-transitory computer-readable storage medium having embodied thereon a program that is executable by a processor, component(s) or subsystem(s) of any of these systems, or a combination thereof.

At operation 1305, the analysis system is configured to, and can, receive contractor information associated with a contractor. The contractor information includes financial information about the contractor and business information about the contractor.

At operation 1310, the analysis system is configured to, and can, generate a contractor quality score based on the contractor information.

In some examples, the contractor quality score is indicative of at least one of a repayment risk associated with the contractor or a collections risk associated with the contractor.

In some examples, the analysis system is configured to, and can, receive lien information associated with the contractor. To generate the contractor quality score at operation 1310, the analysis system can generate the contractor quality score based on the contractor information and the lien information.

In some examples, the analysis system is configured to, and can, create a profile of the contractor. The profile includes at last one of a name of the contractor, an address of the contractor, a website of the contractor, client information associated with the contractor, property information of a property associated with the contractor, general contractor information of a general contractor associated with the contractor, the financial information about the contractor, the business information about the contractor, or a combination thereof. To generate the contractor quality score at operation 1310, the analysis system can generate the contractor quality score based on the profile of the contractor.

In some examples, the contractor quality score is based on at least one of a revenue growth score, a capital equipment score, a quality sub score, a credit score, a general contractor quality score, a quality percentage, an amount of credit offers completed, or information indicative of payment performance on one or more previous credit offers.

In some examples, the analysis system is configured to, and can, input the contractor information (e.g., as part of the input data 1205) into a trained machine learning model (e.g., one of the trained ML model(s) 1225) to generate the contractor quality score (e.g., contractor quality score 1230) based on the contractor information. In some examples, inputting the contractor information into the trained machine learning model includes inputting data tracking the contractor information over time (e.g., as part of the input data 1205) into the trained machine learning model to generate the contractor quality score based on the contractor information. In some examples, the analysis system is configured to, and can, use the contractor quality score as training data (e.g., validation data from validation 1275 and/or training data 1270) to update the trained machine learning model (e.g., as in the further training 1255 and/or the initial training 1265).

At operation 1315, the analysis system is configured to, and can, establish an account credit offer based on the contractor information.

At operation 1320, the analysis system is configured to, and can, adjust the account credit offer based on the contractor quality score.

In some examples, the analysis system is configured to, and can, identify a change to the contractor information (e.g., indicative of a change to at least one of a general contractor or a property owner to which the contractor is connected). To adjust the account credit offer based on the contractor quality score (e.g., as in operation 1320), the analysis system can adjust the credit offer based on the change to the contractor information.

In some examples, the analysis system is configured to, and can, generate an adjustment multiple based on the contractor quality score. To adjust the account credit offer based on the contractor quality score (e.g., as in operation 1320), the analysis system can multiply the account credit offer by the adjustment multiple.

While various flow diagrams provided and described above may show a particular order of operations performed by certain embodiments of the disclosed systems and methods, it should be understood that such order is exemplary (e.g., alternative embodiments can perform the operations in a different order, combine certain operations, overlap certain operations, etc.).

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

What is claimed is:

1. A system for contractor analysis, the system comprising:
a memory; and
a processor coupled to the memory, wherein the processor is configured to:
receive contractor information associated with a contractor, wherein the contractor information includes financial information about the contractor and business information about the contractor;
generate a contractor quality score based on the contractor information;
establish an account credit offer based on the contractor information; and
adjust the account credit offer based on the contractor quality score.

2. The system of claim 1, wherein the processor is configured to:
identify a change to the contractor information indicative of a change to at least one of a general contractor or a property owner to which the contractor is connected, wherein the account credit offer is adjusted based on the change to the contractor information.

3. The system of claim 1, wherein the contractor quality score is indicative of at least one of a repayment risk associated with the contractor or a collections risk associated with the contractor.

4. The system of claim 1, wherein the processor is configured to:
receive lien information associated with the contractor, wherein, to generate the contractor quality score, the processor is configured to generate the contractor quality score based on the contractor information and the lien information.

5. The system of claim 1, wherein the processor is configured to:
generate an adjustment multiple based on the contractor quality score, wherein, to adjust the account credit offer based on the contractor quality score, the processor is configured to includes multiply the account credit offer by the adjustment multiple.

6. The system of claim 1, wherein the processor is configured to:
create a profile of the contractor, wherein the profile includes at last one of a name of the contractor, an address of the contractor, a website of the contractor, client information associated with the contractor, property information of a property associated with the contractor, general contractor information of a general contractor associated with the contractor, the financial information about the contractor, or the business information about the contractor,
wherein, to generate the contractor quality score, the processor is configured to generate the contractor quality score based on the profile of the contractor.

7. The system of claim 1, wherein the contractor quality score is based on at least one of a revenue growth score, a capital equipment score, a quality sub score, a credit score, a general contractor quality score, a quality percentage, an amount of credit offers completed, or information indicative of payment performance on one or more previous credit offers.

8. The system of claim 1, wherein the processor is configured to:
input the contractor information into a trained machine learning model to generate the contractor quality score based on the contractor information.

9. The system of claim 8, wherein inputting the contractor information into the trained machine learning model includes inputting data tracking the contractor information over time into the trained machine learning model to generate the contractor quality score based on the contractor information.

10. The system of claim 8, wherein the processor is configured to:
use the contractor quality score as training data to update the trained machine learning model.

11. A computer-implemented method for contractor analysis, the method comprising:
receiving contractor information associated with a contractor, wherein the contractor information includes financial information about the contractor and business information about the contractor;
generating a contractor quality score based on the contractor information;
establishing an account credit offer based on the contractor information; and
adjusting the account credit offer based on the contractor quality score.

12. The computer-implemented method of claim 11, further comprising:
identify a change to the contractor information indicative of a change to at least one of a general contractor or a property owner to which the contractor is connected, wherein the adjusting of the account credit offer is based on the change to the contractor information.

13. The computer-implemented method of claim 11, wherein the contractor quality score is indicative of at least one of a repayment risk associated with the contractor or a collections risk associated with the contractor.

14. The computer-implemented method of claim 11, further comprising:
receiving lien information associated with the contractor, wherein generating the contractor quality score includes generating the contractor quality score based on the contractor information and the lien information.

15. The computer-implemented method of claim 11, further comprising:
generating an adjustment multiple based on the contractor quality score, wherein adjusting the account credit offer based on the contractor quality score includes multiplying the account credit offer by the adjustment multiple.

16. The computer-implemented method of claim 11, further comprising:
creating a profile for the contractor, wherein the profile includes at last one of a name of the contractor, an address of the contractor, a website of the contractor, client information associated with the contractor, property information of a property associated with the contractor, general contractor information of a general contractor associated with the contractor, the financial information about the contractor, or the business information about the contractor,
wherein the generating of the contractor quality score includes generating the contractor quality score based on the profile of the contractor.

17. The computer-implemented method of claim 11, further comprising:
inputting the contractor information into a trained machine learning model to generate the contractor quality score based on the contractor information.

18. The computer-implemented method of claim 17, wherein inputting the contractor information into the trained machine learning model includes inputting data tracking the contractor information over time into the trained machine learning model to generate the contractor quality score based on the contractor information.

19. The computer-implemented method of claim 17, further comprising:
using the contractor quality score as training data to update the trained machine learning model.

20. A non-transitory computer readable storage medium having embodied thereon a program, wherein the program is executable by a processor to perform a method of contractor analysis, the method comprising:
receiving contractor information associated with a contractor, wherein the contractor information includes financial information about the contractor and business information about the contractor;
generating a contractor quality score based on the contractor information;
establishing an account credit offer based on the contractor information; and
adjusting the account credit offer based on the contractor quality score.
